(19) United States
(12) Patent Application Publication
(10) Pub. No.: US 2016/0054666 A1
(43) Pub. Date: Feb. 25, 2016

(54) ELECTROPHOTOGRAPHIC PHOTOSENSITIVE MEMBER, METHOD FOR PRODUCING ELECTROPHOTOGRAPHIC PHOTOSENSITIVE MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Atsushi Okuda, Yokohama-shi (JP); Nobuhiro Nakamura, Numazu-shi (JP); Kunihiko Sekido, Suntou-gun (JP); Michiyo Sekiya, Atami-shi (JP); Yota Ito, Mishima-shi (JP); Kenichi Kaku, Newcastle Upon Tyne (GB); Hiroyuki Tomono, Numazu-shi (JP); Yuka Ishiduka, Suntou-gun (JP)

(21) Appl. No.: 14/932,818

(22) Filed: Nov. 4, 2015

Related U.S. Application Data
(62) Division of application No. 13/931,215, filed on Jun. 28, 2013.

(30) Foreign Application Priority Data
Jun. 29, 2012 (JP) 2012-147160
Apr. 25, 2013 (JP) 2013-093091
May 28, 2013 (JP) 2013-112112

(51) Int. Cl. G03G 5/14; G03G 5/04

(52) U.S. Cl. CPC G03G 5/142; G03G 5/04

(57) ABSTRACT

An undercoat layer of an electrophotographic photosensitive member contains a polymerized product of (cured material) a composition that contains a particular crosslinking agent, a particular resin, and a particular charge transporting substance.

### CROSS REFERENCE TO RELATED APPLICATIONS

This application is a Divisional of U.S. patent application Ser. No. 13/931,215 filed Jun. 28, 2013, which claims priority to Japanese Patent Application No. 2013-112112 filed May 28, 2013, Japanese Patent Application No. 2013-093091 filed Apr. 25, 2013, and Japanese Patent Application No. 2012-147160 filed Jun. 29, 2012, each of which are hereby incorporated by reference herein in their entireties.

### BACKGROUND OF THE INVENTION

1. Field of the Invention

The present invention relates to an electrophotographic photosensitive member, a method for producing an electrophotographic photosensitive member, and a process cartridge and an electrophotographic apparatus that include the electrophotographic photosensitive member.

2. Description of the Related Art

Currently, the mainstream electrophotographic photosensitive members mounted in process cartridges and electrophotographic apparatuses are those that contain organic photoconductive substances. Such electrophotographic photosensitive members typically each have a support and a photosensitive layer on the support. An undercoat layer is often provided between the support and the photosensitive layer to suppress charge injection from the support side to the photosensitive layer side and occurrence of image defects such as fogging.

In recent years, charge generating substances with higher sensitivity have been increasing used. However, since the amount of charges generated is increased with the increasing sensitivity of the charge generating substances, charges tend to dwell in the photosensitive layer and a problem of ghosting tends to occur. In particular, a phenomenon called positive ghosting in which the density of the output image becomes higher only in the portions irradiated with light during previous rotation is likely to occur.

Such a ghosting phenomenon has been suppressed by, for example, adding an electron transporting substance to the undercoat layer.

PCT Japanese Translation Patent Publication No. 2009-505156 discloses an undercoat layer that contains a polymer derived from a fused polymer (electron transporting substance) that has an aromatic tetracarbonylbisimide skeleton and crosslinking sites and a crosslinking agent. PCT Japanese Translation Patent Publication No. 2009-505156 proposes a technique for avoiding elution of an electron transporting substance from a photosensitive layer formed on the undercoat layer in the case where the electron transporting substance is also added to the undercoat layer. According to this technology, a curable material that is sparingly soluble in a solvent contained in a coating solution for forming a photosensitive layer is used in the undercoating layer. Moreover, Japanese Patent Laid-Open Nos. 2003-330209 and 2008-299344 disclose an undercoat layer that contains a polymer derived from an electron transporting substance that has a non-hydrolyzable polymerizable functional group.

In recent years, the quality requirements for the electrophotographic images have become more and more stringent and the permissible range for the positive ghosting has also narrowed.

The inventors of the present invention have conducted extensive studies and found that the techniques disclosed in PCT Japanese Translation Patent Publication No. 2009-505156 and Japanese Patent Laid-Open Nos. 2003-330209 and 2008-299344 have room for improvements as to suppression (reduction) of positive ghosting and change in positive ghosting level between before and after continuous image output. According to these techniques, the undercoat layer is uneven since components having the same structure aggregate and thus reduction of the positive ghosting has not been from the initial point to after the repeated use.

### SUMMARY OF THE INVENTION

The present invention provides a electrophotographic photosensitive member that further suppresses positive ghosting and a method for producing the electrophotographic photosensitive member. A process cartridge and an electrophotographic apparatus that include the electrophotographic photosensitive member are also provided.

An aspect of the present invention provides an electrophotographic photosensitive member that includes a support, an undercoat layer formed on the support, and a photosensitive layer formed on the undercoat layer. The undercoat layer includes a polymerized product of a composition containing (i) to (iii):

(i) at least one selected from the group consisting of a compound represented by formula (C1) below, an oligomer of the compound represented by formula (C1), a compound represented by formula (C2) below, an oligomer of the compound represented by formula (C2), a compound represented by formula (C3) below, an oligomer of the compound represented by formula (C3), a compound represented by formula (C4) below, an oligomer of the compound represented by formula (C4), a compound represented by formula (C5) below, and an oligomer of the compound represented by formula (C5)

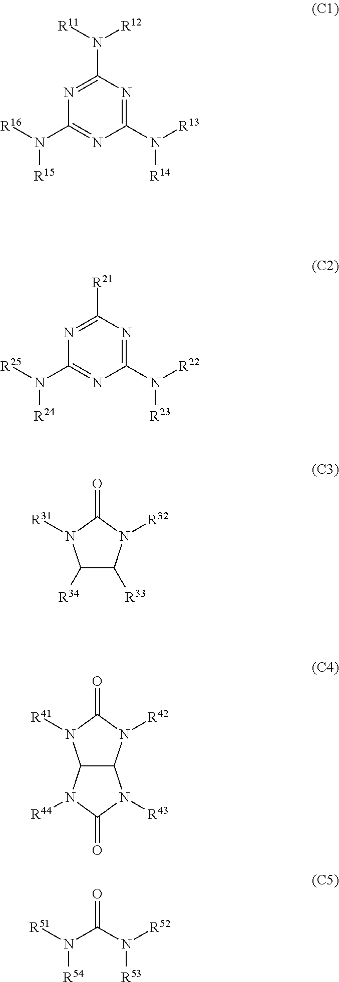

where R¹¹ to R¹⁶, R²² to R²⁵, R³¹ to R³⁴, R⁴¹ to R⁴⁴, and R⁵¹ to R⁵⁴ each independently represent a hydrogen atom, a hydroxy group, an acyl group, or a monovalent group represented by —CH₂—OR¹,
at least one of the R¹¹ to R¹⁶, at least one of the R²² to R²⁵, at least one of the R³¹ to R³⁴, at least one of the R⁴¹ to R⁴⁴, and at least one of the R⁵¹ to R⁵⁴ are each the monovalent group represented by —CH₂—OR¹,
R¹ represents a hydrogen atom, or an alkyl group having 1 to 10 carbon atoms, and
R²¹ represents an aryl group, an aryl group substituted with an alkyl group, a cycloalkyl group, or a cycloalkyl group substituted with an alkyl group;

(ii) a resin having a repeating structural unit represented by formula (B) below

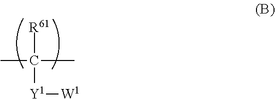

where R⁶¹ represents a hydrogen atom or an alkyl group, Y¹ represents a single bond, an alkylene group, or a phenylene group, and W¹ represents a hydroxy group, a thiol group, an amino group, a carboxyl group, or a methoxy group; and

(iii) an electron transporting substance having at least one substituent selected from the group consisting of a hydroxy group, a thiol group, an amino group, a carboxyl group, and a methoxy group.

Another aspect of the present invention provides a method for producing the electrophotographic photosensitive member. The method includes the steps of forming a coating film by using a coating solution for an undercoat layer, the coating solution containing the composition and heat-drying the coating film to polymerize the composition and form the undercoat layer.

Yet another aspect of the present invention provides a process cartridge detachably attachable to a main body of an electrophotographic apparatus. The process cartridge includes the electrophotographic photosensitive member and at least one device selected from the group consisting of a charging device, a developing device, a transferring device, and a cleaning device. The electrophotographic photosensitive member and the at least one device are integrally supported.

Still another aspect of the present invention provides an electrophotographic apparatus that includes the electrophotographic photosensitive member, a charging device, an exposure device, a developing device, and a transferring device.

Further features of the present invention will become apparent from the following description of exemplary embodiments with reference to the attached drawings.

### BRIEF DESCRIPTION OF THE DRAWINGS

FIG. 1 is a schematic diagram of an electrophotographic apparatus that includes a process cartridge that includes an electrophotographic photosensitive member.

FIG. 2 is a diagram illustrating a print pattern used for evaluating ghost images.

FIG. 3 is a diagram illustrating a Keima-pattern.

FIGS. 4A and 4B illustrate examples of the layer configuration of an electrophotographic photosensitive member.

### DESCRIPTION OF THE EMBODIMENTS

The inventors have made the following presumptions on the reason why an electrophotographic photosensitive member having an undercoat layer of the present invention achieves a superior effect of highly suppressing positive ghosting.

A polymerized product is formed as the following components (i) to (iii) bond to each other:

(i) at least one selected from the group consisting of a compound represented by formula (C1) above, an oligomer of a compound represented by formula (C1) above, a compound represented by formula (C2) above, an oligomer of a compound represented by formula (C2) above, a compound represented by formula (C3) above, an oligomer of a compound represented by formula (C3) above, a compound represented by formula (C4) above, an oligomer of a compound represented by formula (C4) above, a compound represented by formula (C5) above, and an oligomer of a compound represented by formula (C5) above (may be collectively referred to as an “amine compound” or “amine compound of the present invention” hereinafter);

(ii) a resin having a repeating unit represented by formula (B); and

(iii) an electron transporting substance that has at least one substituent selected from the group consisting of a hydroxyl group, a thiol group, an amino group, a carboxyl group, and a methoxy group.

When the undercoat layer contains such a polymerized product, electrons can be transported and the undercoat layer becomes sparingly soluble in solvents.

However, an undercoat layer that contains a polymerized product prepared by polymerizing a composition constituted by several materials (amine compound, electron transporting substance, and resin) tends to be inhomogeneous since materials having the same structure tend to aggregate. As a result, electrons tend to dwell in the undercoat layer or at the interface between the undercoat layer and the photosensitive layer and ghosting easily occurs. Because the amine compound of the present invention has a cyclic structure or a urea structure and has one or more monovalent groups represented by —CH₂—OR¹, the amine compounds do not come next to each other and an appropriate bulkiness and a large volume are achieved. Accordingly, it is presumed that when the functional groups (—CH₂—OR¹) of the amine compounds polymerize or cross-link with the resin, the amine compound pushes the molecular chains of the resin and suppresses aggregation (localization) of the molecular chains of the resin. Since an electron transporting substance is bonded to the amine compound bonded to the molecular chains of the resin whose localization is suppressed, the segments derived from the electron transporting substance also distribute evenly in the undercoat layer without localization. As a result, a polymerized product in which structures derived from the amine compound, the electron transporting substance, and the resin are evenly distributed can be obtained, dwelling of electrons can be significantly reduced, and a higher ghosting suppressing effect is achieved.

The electrophotographic photosensitive member of the present invention includes a support, an undercoat layer on the support, and a photosensitive layer on the undercoat layer. The photosensitive layer may be a layered (separated function) photosensitive layer constituted by a charge generating layer that contains a charge generating substance and a charge transport layer (hole transport layer) that contains a charge transporting substance (hole transporting substance). From the viewpoint of electrophotographic properties, the layered photosensitive layer may be a normal-order layered photosensitive layer that includes a charge generating layer and a charge transport layer stacked in that order from the support side.

FIGS. 4A and 4B show examples of the layer configuration of electrophotographic photosensitive members. The electrophotographic photosensitive member shown in FIG. 4A includes a support 101, an undercoat layer 102, and a photosensitive layer 103. The electrophotographic photosensitive member shown in FIG. 4B includes a support 101, an undercoat layer 102, a charge generating layer 104, and a charge transport layer 105.

A cylindrical electrophotographic photosensitive member including a cylindrical support and a photosensitive layer (electron generating layer and charge transport layer) disposed on the support is widely used as a common electrophotographic photosensitive member. The electrophotographic photosensitive member may also have other shapes such as a belt shape and a sheet shape.

### Undercoat Layer

An undercoat layer is interposed between the support and the photosensitive layer or between the conductive layer and the photosensitive layer described below.

The undercoat layer contains a polymerized product of a composition that contains (i) at least one selected from the group consisting of a compound represented by formula (C1), an oligomer of a compound represented by formula (C1), a compound represented by formula (C2), an oligomer of a compound represented by formula (C2), a compound represented by formula (C3), an oligomer of a compound represented by formula (C3), a compound represented by formula (C4), an oligomer of a compound represented by formula (C4), a compound represented by formula (C5), and an oligomer of a compound represented by formula (C5); (ii) a resin having a repeating unit represented by formula (B); (iii) and an electron transporting substance that has at least one substituent selected from the group consisting of a hydroxyl group, a thiol group, an amino group, a carboxyl group, and a methoxy group. The undercoat layer may contain two or more such compounds.

The undercoat layer is formed by forming a coating film by using a coating solution that contains a composition containing an amine compound, a resin, and an electron transporting substance and drying the coating film by heating to polymerize the composition and form an undercoat layer. After formation of the coating film, the compounds are polymerized (hardened) through chemical reactions. During this process, heating is conducted to accelerate the chemical reaction and polymerization.

Examples of the solvent used to prepare a coating solution for forming the undercoat layer include alcohol-based solvents, sulfoxide-based solvents, ketone-based solvents, ether-based solvents, ester-based solvents, and aromatic hydrocarbon solvents.

The polymerized product content relative to the total mass of the undercoat layer is preferably 50% by mass or more and 100% by mass or less and more preferably 80% by mass or more and 100% by mass or less from the viewpoint of suppressing ghosting.

The undercoat layer may contain other resins, a crosslinking agent other than the amine compound described above, organic particles, inorganic particles, a leveling agent, and a catalyst that accelerates curing in addition to the polymer described above in order to enhance the film forming property and electrical properties of the undercoat layer. However, the contents of these agents in the undercoat layer are preferably less than 50% by mass and more preferably less than 20% by mass relative to the total mass of the undercoat layer.

### Electron Transporting Substance

Next, an electron transporting substance that has at least one substituent selected from the group consisting of a hydroxy group, a thiol group, an amino group, a carboxyl group, and a methoxy group is described. Specific examples of the electron transporting substance include compounds represented by formulae (A1) to (A9) below.

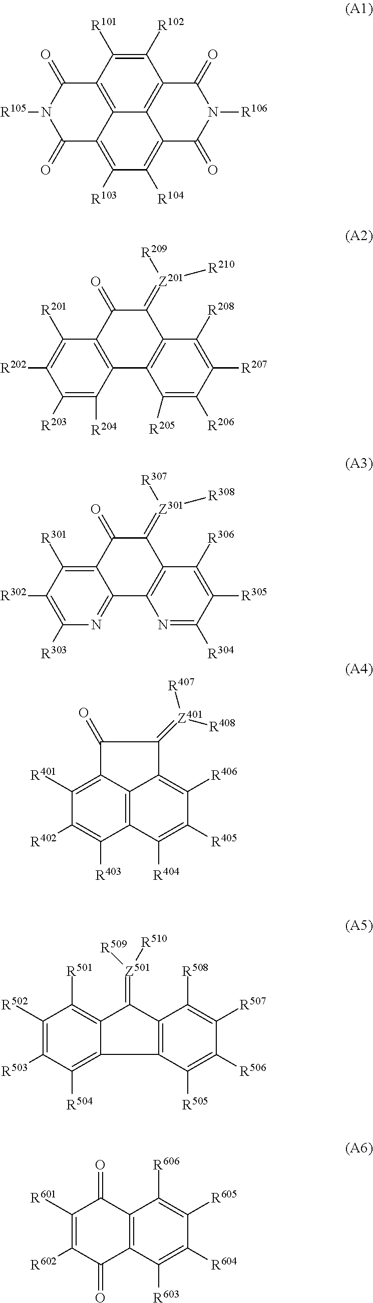

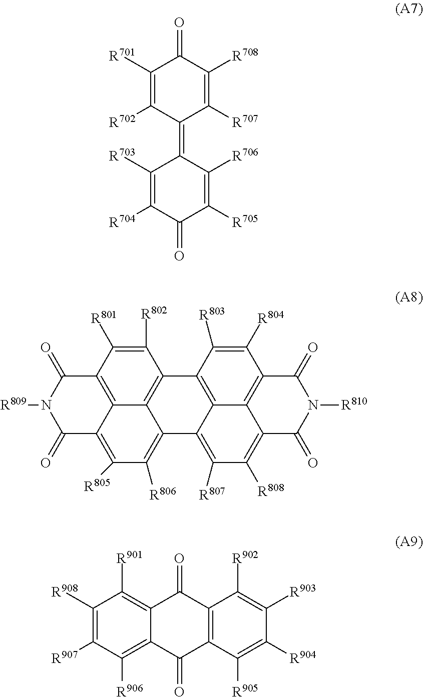

In formulae (A1) to (A9), R¹⁰¹ to R¹⁰⁶, R²⁰¹ to R²¹⁰, R³⁰¹ to R³⁰⁸, R⁴⁰¹ to R⁴⁰⁸, R⁵⁰¹ to R⁵¹⁰, R⁶⁰¹ to R⁶⁰⁶, R⁷⁰¹ to R⁷⁰⁸, R⁸⁰¹ to R⁸¹⁰, and R⁹⁰¹ to R⁹⁰⁸ each independently represents a monovalent group represented by formula (A) below, a hydrogen atom, a cyano group, a nitro group, a halogen atom, an alkoxycarbonyl group, a substituted or unsubstituted alkyl group, a substituted or unsubstituted aryl group, or a substituted or unsubstituted heterocyclic group; at least one of R¹⁰¹ to R¹⁰⁶, at least one of R²⁰¹ to R²¹⁰, at least one of R³⁰¹ to R³⁰⁸, at least one of R⁴⁰¹ to R⁴⁰⁸, at least one of R⁵⁰¹ to R⁵¹⁰, at least one of R⁶⁰¹ to R⁶⁰⁶, at least one of R⁷⁰¹ to R⁷⁰⁸, at least one of R⁸⁰¹ to R⁸¹⁰, and at least one of R⁹⁰¹ to R⁹⁰⁸ are each a monovalent group represented by formula (A) below; one of carbon atoms in the alkyl group may be replaced with O, S, NH, or NR¹⁰⁰¹ (R¹⁰⁰¹ is an alkyl group); the substituent of the substituted alkyl group is an alkyl group, an aryl group, a halogen atom, or a carbonyl group; the substituent of the substituted aryl group or the substituent of the substituted heterocyclic group is halogen atom, a nitro group, a cyano group, an alkyl group, a halogen-substituted alkyl group, an alkoxy group, or a carbonyl group; Z²⁰¹, Z³⁰¹, Z⁴⁰¹, and Z⁵⁰¹ each independently represents a carbon atom, a nitrogen atom, or an oxygen atom; R²⁰⁹ and R²¹⁰ are absent when Z²⁰¹ is an oxygen atom; R²¹⁰ is absent when Z²⁰¹ is a nitrogen atom; R³⁰⁷ and R³⁰⁸ are absent when Z³⁰¹ is an oxygen atom; R³⁰⁸ is absent when Z³⁰¹ is a nitrogen atom; R⁴⁰⁷ and R⁴⁰⁸ are absent when Z⁴⁰¹ is an oxygen atom; R⁴⁰⁸ is absent when Z⁴⁰¹ is a nitrogen atom; R⁵⁰⁹ and R⁵¹⁰ are absent when Z⁵⁰¹ is an oxygen atom; and R⁵¹⁰ is absent when Z⁵⁰¹ is a nitrogen atom.

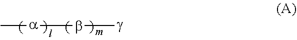

In formula (A), at least one of α, β, and γ is a group having a substituent, the substituent being at least one group selected from the group consisting of a hydroxy group, a thiol group, an amino group, a carboxyl group, and a methoxy group; l and m each independently represents 0 or 1, the sum of 1 and m is 0 to 2; α represents an alkylene group having 1 to 6 main-chain atoms, an alkylene group having 1 to 6 main-chain atoms and substituted with an alkyl group having 1 to 6 carbon atoms, an alkylene group having 1 to 6 main-chain atoms and substituted with a benzyl group, an alkylene group having 1 to 6 main-chain atoms and substituted with an alkoxycarbonyl group, an alkylene group having 1 to 6 main-chain atoms and substituted with a phenyl group and may have at least one substituent selected from the group consisting of a hydroxy group, a thiol group, an amino group, a carboxyl group, and a methoxy group; and one of the carbon atoms in the main chain of the alkylene group may be replaced with 0, NH, S, or NR¹⁹, R¹⁹ representing an alkyl group.

In the formula (A), β represents a phenylene group, a phenylene group substituted with an alkyl group having 1 to 6 carbon atoms, a phenylene group substituted with a nitro group, a phenylene group substituted with a halogen atom, or a phenylene group substituted with an alkoxy group and may have at least one substituent selected from the group consisting of a hydroxy group, a thiol group, an amino group, a carboxyl group, and a methoxy group.

In the formula (A), γ represents a hydrogen atom, an alkyl group having 1 to 6 main-chain atoms, or an alkyl group having 1 to 6 main-chain atoms and substituted with an alkyl group having 1 to 6 carbon atoms and these groups may have at least one substituent selected from the group consisting of a hydroxy group, a thiol group, an amino group, a carboxyl group, and a methoxy group. When the molecular weight of the compounds represented by formulae (A1) to (A9) above (hereinafter the compound may be referred to as “compounds (A1) to (A9)”) is close to the molecular weight of the amine compound, it is easier to have the compounds (A1) to (A9) evenly distributed in the polymer produced. Accordingly, the ratio of the molecular weight of the compound (A1) to (A9) to the molecular weight of the amine compound described above is preferably in the range of 0.5 to 1.5 and more preferably in the range of 0.8 to 1.2.

The weight-average molecular weight (Mw) of the compounds (A1) to (A9) is preferably 150 or more and 1000 or less and more preferably 190 or more and 650 or less since aggregation of the charge transport compound in the polymerized product is suppressed, the evenness of the undercoat layer is enhanced, and a positive ghosting reducing effect is achieved.

Specific examples of the compound represented by formula (A1) above are shown in Tables 1-1, 1-2, 1-3, 1-4, 1-5, and 1-6. In the tables, γ represents a hydrogen atom when “-” appears in the γ column and this hydrogen atom appears in the α column or the β column.

TABLE 1-1

| Example | | | | | | | A | | |
|---|---|---|---|---|---|---|---|---|---|
| compound | R¹⁰¹ | R¹⁰² | R¹⁰³ | R¹⁰⁴ | R¹⁰⁵ | R¹⁰⁶ | α | β | γ |
| A101 | H | H | H | H | 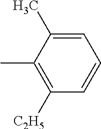 | A | 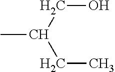 | — | — |
| A102 | H | H | H | H | 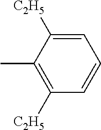 | A | 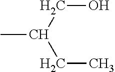 | — | — |
| A103 | H | H | H | H | 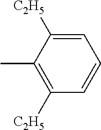 | A | — | 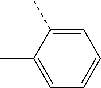 | 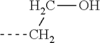 |
| A104 | H | H | H | H | 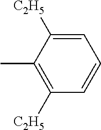 | A | — | 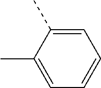 | 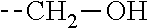 |
| A105 | H | H | H | H | 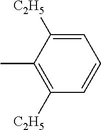 | A | — | 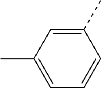 | 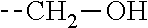 |
| A106 | H | H | H | H | 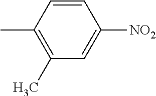 | A | 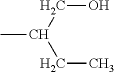 | — | — |
| A107 | H | H | H | H | 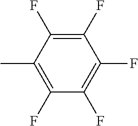 | A | 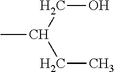 | — | — |
| A108 | H | H | H | H | 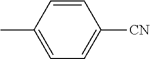 | A | 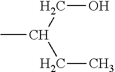 | — | — |
| A109 | H | H | H | H | 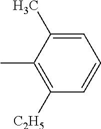 | A | —C₅H₁₀—OH | — | — |
| A110 | H | H | H | H | —C₆H₁₃ | A | 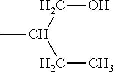 | — | — |
| A111 | H | H | H | H | 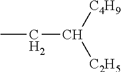 | A | — | 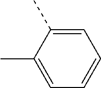 | 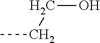 |
| A112 | H | H | H | H | 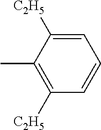 | A | — | 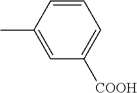 | — |
| A113 | H | H | H | H | 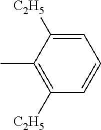 | A | — | 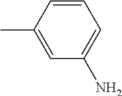 | — |
| A114 | H | H | H | H | 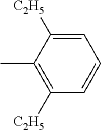 | A | — | 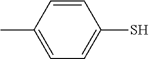 | — |
| A115 | H | H | H | H | 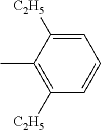 | A | — | 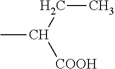 | — |
| A116 | H | H | H | H | 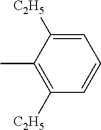 | A | — | 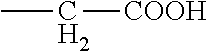 | — |

TABLE 1-2

| Example | | | | | | | | | |
|---|---|---|---|---|---|---|---|---|---|
| com- | | | | | | | A | | |
| pound | R¹⁰¹ | R¹⁰² | R¹⁰³ | R¹⁰⁴ | R¹⁰⁵ | R¹⁰⁶ | α | β | γ |
| A117 | H | H | H | H | 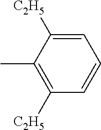 | A | — | 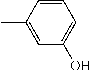 | — |
| A118 | H | H | H | H | 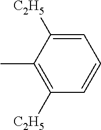 | A | — | 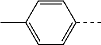 | 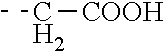 |
| A119 | 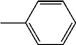 | H | H | 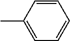 | 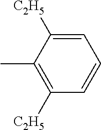 | A | 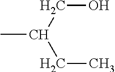 | — | — |
| A120 | CN | H | H | CN | 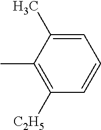 | A | 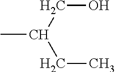 | — | — |
| A121 | A | H | H | H | 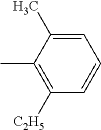 | 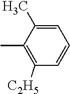 | —COOH | — | — |
| A122 | H | NO₂ | H | NO₂ | 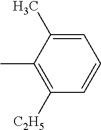 | A | 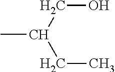 | — | — |
| A123 | H | H | H | H | 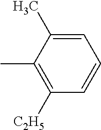 | A | 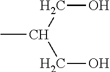 | — | — |
| A124 | H | H | H | H | A | A | 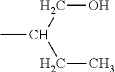 | — | — |
| A125 | H | H | H | H | A | A | — | 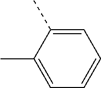 | —CH₂—OH |
| A126 | H | H | H | H | A | A | — | 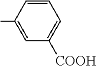 | — |
| A127 | H | H | H | H | A | A | — | 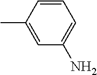 | — |
| A128 | H | H | H | H | A | A | — | 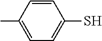 | — |
| A129 | H | H | H | H | A | A | — | 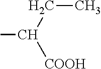 | — |
| A130 | H | H | H | H | A | A | — | 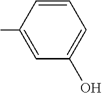 | — |
| A131 | H | H | H | H | 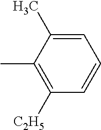 | A | 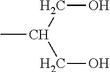 | — | — |
| A132 | H | H | H | H | 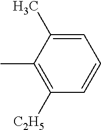 | A | 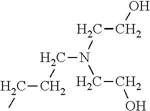 | — | — |
| A133 | H | H | H | H | 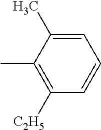 | A | 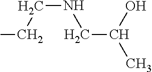 | — | — |

TABLE 1-3

| Example | | | | | | | A | | |
|---|---|---|---|---|---|---|---|---|---|
| compound | R¹⁰¹ | R¹⁰² | R¹⁰³ | R¹⁰⁴ | R¹⁰⁵ | R¹⁰⁶ | α | β | γ |
| A134 | H | H | H | H | 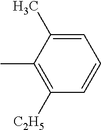 | A | 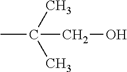 | — | — |
| A135 | H | H | H | H | A | A | 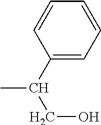 | — | — |
| A136 | H | H | H | H | A | A | 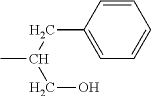 | — | — |
| A137 | H | H | H | H | A | A | 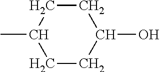 | — | — |
| A138 | H | H | H | H | A | A | — | 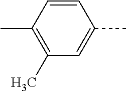 | 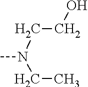 |
| A139 | H | H | H | H | 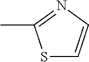 | A | 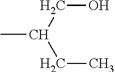 | — | — |
| A140 | H | H | H | H | 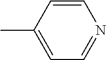 | A | 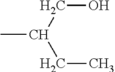 | — | — |
| A141 | H | H | H | H | 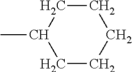 | A | 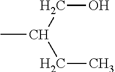 | — | — |
| A142 | H | H | H | H | A | A | 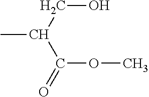 | — | — |
| A143 | CN | H | H | CN | 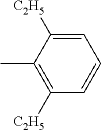 | A | 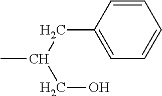 | — | — |
| A144 | H | H | H | H | —C₂H₄—O—C₂H₅ | A | 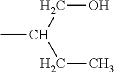 | — | — |
| A145 | H | H | H | H | 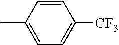 | A | —C₂H₄—O—C₂H₄—OH | — | — |
| A146 | H | H | H | H | A | A | 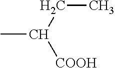 | — | — |
| A147 | H | H | H | H | 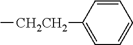 | A | 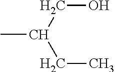 | — | — |
| A148 | H | H | H | H | 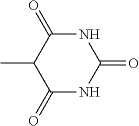 | A | —C₂H₄—O—C₂H₄—OH | — | — |
| A149 | H | H | H | H | 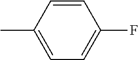 | A | 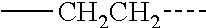 | 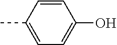 | — |
| A150 | H | H | H | H | 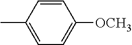 | A | — | 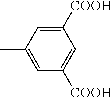 | — |
| A151 | H | H | H | H | A | A | — | 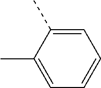 | 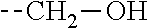 |

TABLE 1-4

| Example | | | | | | | A | | | A′ | | |
|---|---|---|---|---|---|---|---|---|---|---|---|---|
| compound | R¹⁰¹ | R¹⁰² | R¹⁰³ | R¹⁰⁴ | R¹⁰⁵ | R¹⁰⁶ | α | β | γ | α | β | γ |
| A152 | H | H | H | H | A | A′ | 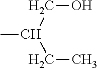 | — | — | 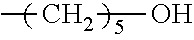 | — | — |
| A153 | H | H | H | H | A | A′ | — | 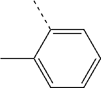 | 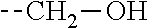 | 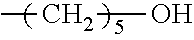 | — | — |
| A154 | H | H | H | H | A | A′ | — | 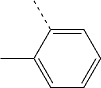 | 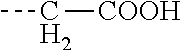 | 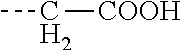 | — | — |
| A155 | H | H | H | H | A | A′ | — | 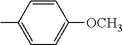 | — | 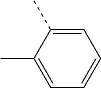 | 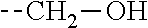 | — |
| A156 | H | H | H | H | A | A′ | 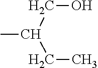 | — | — | 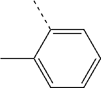 | 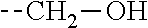 | — |

TABLE 1-5

| Example | | | | | | | A | | |
|---|---|---|---|---|---|---|---|---|---|
| compound | R¹⁰¹ | R¹⁰² | R¹⁰³ | R¹⁰⁴ | R¹⁰⁵ | R¹⁰⁶ | α | β | γ |
| A157 | H | H | H | H | A | A | 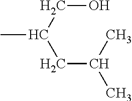 | — | — |
| A158 | H | H | H | H | A | A | 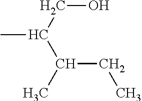 | — | — |
| A159 | H | H | H | H | A | A | 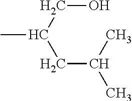 | — | — |
| A160 | H | H | H | H | —C₆H₁₂—OH | A | 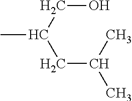 | — | — |
| A161 | H | H | H | H | 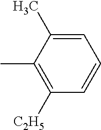 | A | 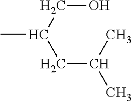 | — | — |
| A162 | H | H | H | H | A | A | 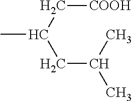 | — | — |
| A163 | H | H | H | H | 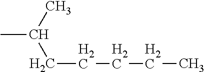 | A | —C₂H₄—S—C₂H₄—OH | — | — |
| A164 | H | H | H | H | A | A | 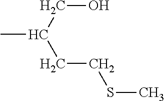 | — | — |
| A165 | H | H | H | H | A | A | 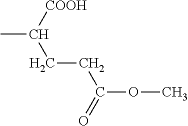 | — | — |
| A166 | H | H | H | H | —C₂H₄—O—C₂H₅ | A | 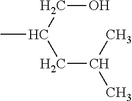 | — | — |
| A167 | H | H | H | H | —C₂H₄—O—C₂H₅ | A | 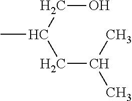 | — | — |
| A168 | H | H | H | H | 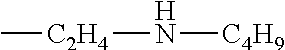 | A | 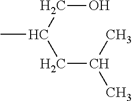 | — | — |
| A169 | H | H | H | H | 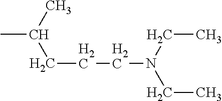 | A | 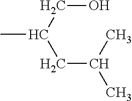 | — | — |
| A170 | H | H | H | H | 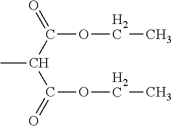 | A | 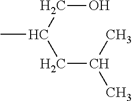 | — | — |

TABLE 1-6

| Example | | | | | | | A | | | A′ | | |
|---|---|---|---|---|---|---|---|---|---|---|---|---|
| compound | R¹⁰¹ | R¹⁰² | R¹⁰³ | R¹⁰⁴ | R¹⁰⁵ | R¹⁰⁶ | α | β | γ | α | β | γ |
| A171 | H | H | H | H | A | A′ | 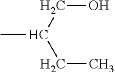 | — | — | 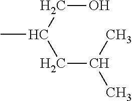 | — | — |
| A172 | H | H | H | H | A | A′ | —C₂H₄—O—C₂H₄—OH | — | — | 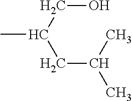 | — | — |
| A173 | H | H | H | H | A | A′ | —C₆H₁₂—OH | — | — | 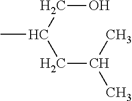 | — | — |
| A174 | H | H | H | H | A | A′ | 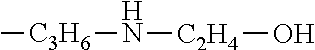 | — | — | 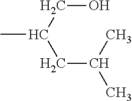 | — | — |
| A175 | H | H | H | H | A | A′ | —C₂H₄—O—C₂H₄—OH | — | — | 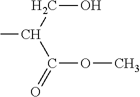 | — | — |
| A176 | H | H | H | H | A | A′ | —C₂H₄—O—C₂H₄—OH | — | — | 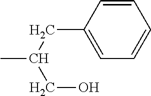 | — | — |
| A177 | H | H | H | H | A | A′ | —C₂H₄—S—C₂H₄—OH | — | — | 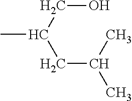 | — | — |
| A178 | H | H | H | H | A | A′ | 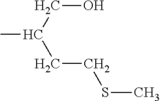 | — | — | 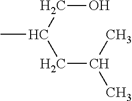 | — | — |
| A179 | H | H | H | H | A | A′ | 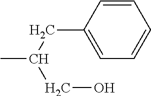 | — | — | 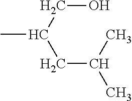 | — | — |
| A180 | H | H | H | H | A | A′ | 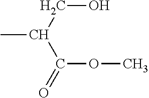 | — | — | 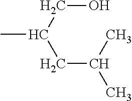 | — | — |
| A181 | H | H | H | H | A | A′ | —C₂H₄—S—C₂H₄—OH | — | — | 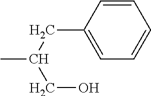 | — | — |

Specific examples of the compound represented by formula (A2) above are shown in Tables 2-1, 2-2, and 2-3. In the tables, γ represents a hydrogen atom when “-” appears in the γ column and this hydrogen atom appears in the α column or the β column.

TABLE 2-1

| Ex- | | | | | | | | | | | | | | |
|---|---|---|---|---|---|---|---|---|---|---|---|---|---|---|
| am- | | | | | | | | | | | | | | |
| ple | | | | | | | | | | | | | | |
| com- | | | | | | | | | | | | A | | |
| pound | R²⁰¹ | R²⁰² | R²⁰³ | R²⁰⁴ | R²⁰⁵ | R²⁰⁶ | R²⁰⁷ | R²⁰⁸ | R²⁰⁹ | R²¹⁰ | Z²⁰¹ | α | β | γ |
| A201 | H | H | A | H | H | H | H | H | — | — | O | — | 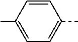 | 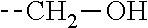 |
| A202 | H | H | A | H | H | H | H | H | — | — | O | — | 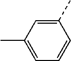 | 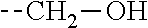 |
| A204 | H | H | A | H | H | H | H | H | — | — | O | — | 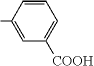 | — |
| A205 | H | H | A | H | H | H | H | H | — | — | O | — | 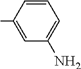 | — |
| A206 | H | H | A | H | H | H | H | H | — | — | O | — | 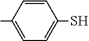 | — |
| A207 | H | H | H | H | H | H | H | H | A | — | N | — | 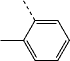 | 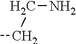 |
| A208 | H | H | H | H | H | H | H | H | A | — | N | — | 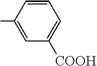 | — |
| A209 | H | H | H | H | H | H | H | H | A | — | N | — | 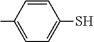 | — |
| A210 | H | H | H | H | H | H | H | H | A | — | N | 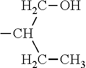 | — | — |
| A211 | CH3 | H | H | H | H | H | H | CH₃ | A | — | N | — | 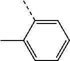 | 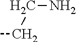 |
| A212 | H | Cl | H | H | H | H | Cl | H | A | — | N | — | 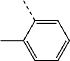 | 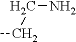 |
| A213 | H | H | 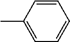 | H | H | 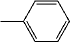 | H | H | A | — | N | — | 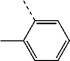 | 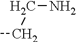 |
| A214 | H | H | 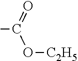 | H | H | 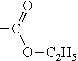 | H | H | A | — | N | — | 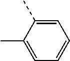 | 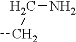 |
| A215 | H | H | H | NO₂ | NO₂ | H | H | H | A | — | N | — | 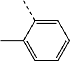 | 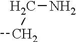 |
| A216 | H | H | A | H | H | A | H | H | — | — | O | — | 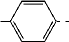 | 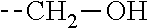 |
| A217 | H | H | A | H | H | A | H | H | — | — | O | — | 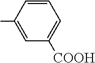 | — |

TABLE 2-2

| Ex- | | | | | | | | | | | | | | |
|---|---|---|---|---|---|---|---|---|---|---|---|---|---|---|
| am- | | | | | | | | | | | | | | |
| ple | | | | | | | | | | | | | | |
| com- | | | | | | | | | | | | A | | |
| pound | R²⁰¹ | R²⁰² | R²⁰³ | R²⁰⁴ | R²⁰⁵ | R²⁰⁶ | R²⁰⁷ | R²⁰⁸ | R²⁰⁹ | R²¹⁰ | Z²⁰¹ | α | β | γ |
| A218 | H | H | A | H | H | A | H | H | — | — | O | — | 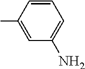 | — |
| A219 | H | H | A | H | H | A | H | H | — | — | O | — | 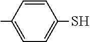 | — |
| A220 | H | H | A | H | H | A | H | H | — | — | O | 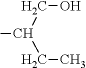 | — | — |
| A221 | H | H | A | H | H | A | H | H | — | — | O | 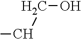 | — | — |
| A222 | H | H | A | H | H | A | H | H | — | — | O | — | — | COOH |
| A223 | H | H | A | H | H | A | H | H | | — | O | — | — | NH₂ |
| A224 | H | A | H | H | H | H | A | H | | — | O | — | 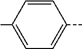 | 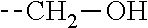 |
| A225 | H | H | A | H | H | A | H | H | CN | CN | C | — | 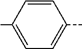 | 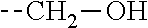 |
| A226 | H | H | A | H | H | A | H | H | CN | CN | C | — | 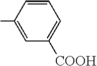 | — |
| A227 | H | H | A | H | H | A | H | H | CN | CN | C | — | 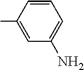 | — |
| A228 | H | H | A | H | H | A | H | H | CN | CN | C | — | 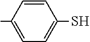 | — |
| A229 | H | H | A | H | H | A | H | H | CN | 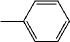 | C | — | 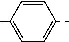 | |
| A230 | H | H | A | H | H | A | H | H | 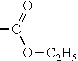 | 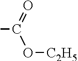 | C | — | 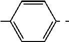 | 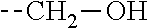 |
| A231 | H | H | H | H | H | H | H | H | A | A | C | — | — | COOH |
| A232 | H | NO₂ | H | H | H | H | NO₂ | H | A | — | N | — | 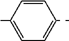 | 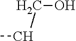 |
| A233 | H | H | | H | H | A | H | H | — | — | O | — | 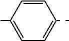 | 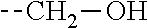 |

TABLE 2-3

| Example | | | | | | | | | | | |
|---|---|---|---|---|---|---|---|---|---|---|---|
| compound | R²⁰¹ | R²⁰² | R²⁰³ | R²⁰⁴ | R²⁰⁵ | R²⁰⁶ | R²⁰⁷ | R²⁰⁸ | R²⁰⁹ | R²¹⁰ | Z²⁰¹ |
| A234 | H | A | H | H | H | H | A′ | H | — | — | O |
| A235 | H | A | H | H | H | H | A′ | H | — | — | O |
| A236 | H | A′ | H | H | H | H | A′ | H | — | — | O |

| Example | A | | | A′ | | |
|---|---|---|---|---|---|---|
| compound | α | β | γ | α | β | γ |
| A234 | 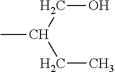 | — | — | — | 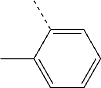 | 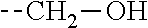 |
| A235 | — | 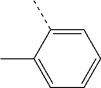 | 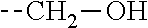 | 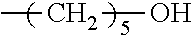 | — | — |
| A236 | — | 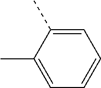 | 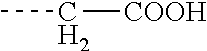 | 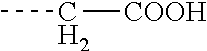 | — | — |

Specific examples of the compound represented by formula (A3) above are shown in Tables 3-1, 3-2, and 3-3. In the tables, γ represents a hydrogen atom when “-” appears in the γ column and this hydrogen atom appears in the α column or the β column.

TABLE 3-1

| Ex- | | | | | | | | | | | | |
|---|---|---|---|---|---|---|---|---|---|---|---|---|
| ample | | | | | | | | | | | | |
| com- | | | | | | | | | | A | | |
| pound | R³⁰¹ | R³⁰² | R³⁰³ | R³⁰⁴ | R³⁰⁵ | R³⁰⁶ | R³⁰⁷ | R³⁰⁸ | Z³⁰¹ | α | β | γ |
| A301 | H | A | H | H | H | H | — | — | O | — | 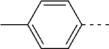 | 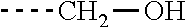 |
| A302 | H | A | H | H | H | H | — | — | O | — | 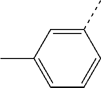 | 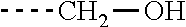 |
| A303 | H | A | H | H | H | H | — | — | O | — | 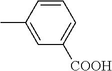 | — |
| A304 | H | A | H | H | H | H | — | — | O | — | 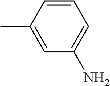 | — |
| A305 | H | A | H | H | H | H | — | — | O | — | 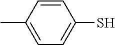 | — |
| A306 | H | H | H | H | H | H | A | — | N | — | 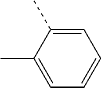 | 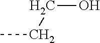 |
| A307 | H | H | H | H | H | H | A | — | N | — | 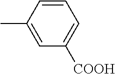 | — |
| A308 | H | H | H | H | H | H | A | — | N | 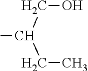 | — | — |
| A309 | CH₃ | H | H | H | H | CH₃ | A | — | N | — | 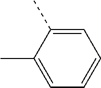 | 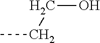 |
| A310 | H | H | Cl | Cl | H | H | A | — | N | — | 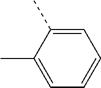 | 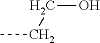 |
| A311 | H | 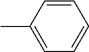 | H | H | 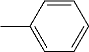 | H | A | — | N | — | 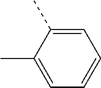 | 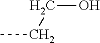 |
| A312 | H | 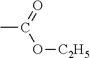 | H | H | 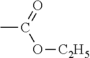 | H | A | — | N | — | 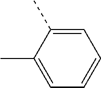 | 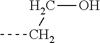 |
| A313 | H | H | H | H | H | H | A | — | N | — | 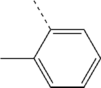 | 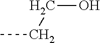 |
| A314 | H | A | H | H | A | H | — | — | O | — | 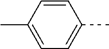 | 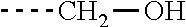 |
| A315 | H | A | H | H | A | H | — | — | O | — | 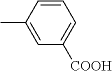 | — |

TABLE 3-2

| Ex- | | | | | | | | | | | | |
|---|---|---|---|---|---|---|---|---|---|---|---|---|
| ample | | | | | | | | | | | | |
| com- | | | | | | | | | | A | | |
| pound | R³⁰¹ | R³⁰² | R³⁰³ | R³⁰⁴ | R³⁰⁵ | R³⁰⁶ | R³⁰⁷ | R³⁰⁸ | Z³⁰¹ | α | β | γ |
| A316 | H | A | H | H | A | H | — | — | O | — | 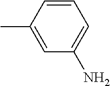 | — |
| A317 | H | A | H | H | A | H | — | — | O | — | 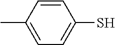 | — |
| A318 | H | A | H | H | A | H | — | — | O | 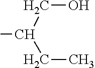 | — | — |
| A319 | H | A | H | H | A | H | — | — | O | 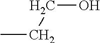 | — | — |
| A320 | H | A | H | H | A | H | — | — | O | — | — | COOH |
| A321 | H | A | H | H | A | H | — | — | O | — | — | NH₂ |
| A322 | H | H | A | A | H | H | — | — | O | — | 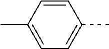 | 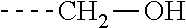 |
| A323 | H | A | H | H | A | H | CN | CN | C | — | 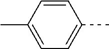 | 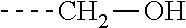 |
| A324 | H | A | H | H | A | H | CN | CN | C | — | 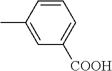 | — |
| A325 | H | A | H | H | A | H | CN | CN | C | — | 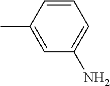 | — |
| A326 | H | A | H | H | A | H | CN | CN | C | — | 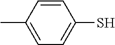 | — |
| A327 | H | A | H | H | A | H | CN | 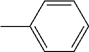 | C | — | 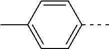 | —CH₂—OH |
| A328 | H | A | H | H | A | H | 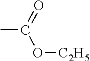 | 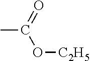 | C | — | 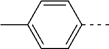 | —CH₂—OH |
| A329 | H | H | H | H | H | H | A | A | C | — | — | COOH |
| A330 | H | H | H | H | H | H | A | — | N | — | 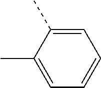 | 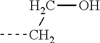 |

TABLE 3-3

| Example | | | | | | | | | | A |
|---|---|---|---|---|---|---|---|---|---|---|
| compound | R³⁰¹ | R³⁰² | R³⁰³ | R³⁰⁴ | R³⁰⁵ | R³⁰⁶ | R³⁰⁷ | R³⁰⁸ | Z³⁰¹ | α |
| A331 | H | A | H | H | A′ | H | H | H | O | 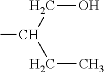 |
| A332 | H | A′ | H | H | A | H | H | H | O | — |
| A333 | H | A | H | H | A′ | H | H | H | O | — |

| Example | A | | A′ | | |
|---|---|---|---|---|---|
| compound | β | γ | α | β | γ |
| A331 | — | — | — | 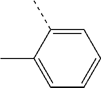 | 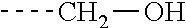 |

| | | | | | |
|---|---|---|---|---|---|
| A332 | 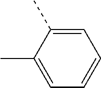 | 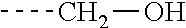 | 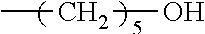 | — | — |
| A333 | 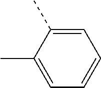 | 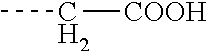 | 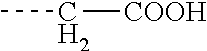 | — | — |

Specific examples of the compound represented by formula (A4) above are shown in Tables 4-1 and 4-2. In the tables, γ represents a hydrogen atom when “-” appears in the γ column and this hydrogen atom appears in the α column or the β column.

TABLE 4-1

| Ex- | | | | | | | | | | | | |
|---|---|---|---|---|---|---|---|---|---|---|---|---|
| am- | | | | | | | | | | | | |
| ple | | | | | | | | | | | | |
| com- | | | | | | | | | | A | | |
| pound | R⁴⁰¹ | R⁴⁰² | R⁴⁰³ | R⁴⁰⁴ | R⁴⁰⁵ | R⁴⁰⁶ | R⁴⁰⁷ | R⁴⁰⁸ | Z⁴⁰¹ | α | β | γ |
| A401 | H | H | A | H | H | H | CN | CN | C | — | 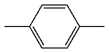 | 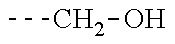 |
| A402 | H | H | A | H | H | H | CN | CN | C | — | 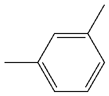 | 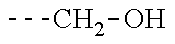 |
| A403 | H | H | A | H | H | H | CN | CN | C | — | 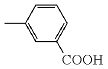 | — |
| A404 | H | H | A | H | H | H | CN | CN | C | — | 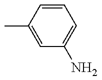 | — |
| A405 | H | H | A | H | H | H | CN | CN | C | — | 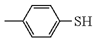 | — |
| A406 | H | H | H | H | H | H | A | — | N | — | 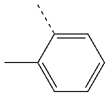 | 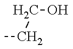 |
| A407 | H | H | H | H | H | H | A | — | N | — | 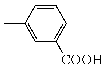 | — |
| A408 | H | H | H | H | H | H | A | — | N | — | 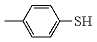 | — |
| A409 | H | H | H | H | H | H | A | — | N | 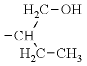 | — | — |
| A410 | CH₃ | H | H | H | H | CH₃ | A | — | N | — | 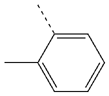 | 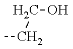 |
| A411 | H | Cl | H | H | Cl | H | A | — | N | — | 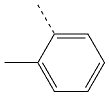 | 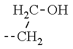 |
| A412 | H | H | 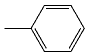 | 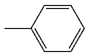 | H | H | A | — | N | — | 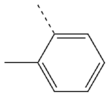 | 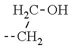 |
| A413 | H | H | 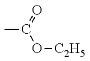 | 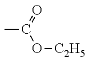 | H | H | A | — | N | — | 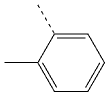 | 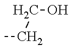 |
| A414 | H | H | H | H | H | H | A | — | N | — | 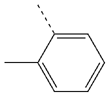 | 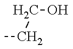 |
| A415 | H | H | A | A | H | H | CN | CN | C | — | 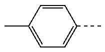 | 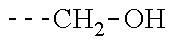 |

TABLE 4-2

| Example | | | | | | | | | | A | | |
|---|---|---|---|---|---|---|---|---|---|---|---|---|
| compound | R⁴⁰¹ | R⁴⁰² | R⁴⁰³ | R⁴⁰⁴ | R⁴⁰⁵ | R⁴⁰⁶ | R⁴⁰⁷ | R⁴⁰⁸ | Z⁴⁰¹ | α | β | γ |
| A416 | H | H | A | A | H | H | CN | CN | C | — | 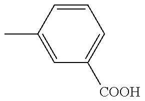 | — |
| A417 | H | H | A | A | H | H | CN | CN | C | — | 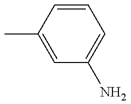 | — |
| A418 | H | H | A | A | H | H | CN | CN | C | — | 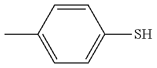 | — |
| A419 | H | H | A | A | H | H | CN | CN | C | 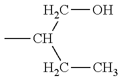 | — | — |
| A420 | H | H | A | A | H | H | CN | CN | C | 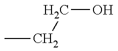 | — | — |
| A421 | H | H | A | A | H | H | CN | CN | C | — | — | COOH |
| A422 | H | H | A | A | H | H | CN | CN | C | — | — | NH₂ |
| A423 | H | A | H | H | A | H | CN | CN | C | — | 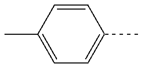 | 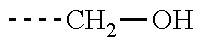 |
| A423 | H | H | A | A | H | H | CN | CN | C | — | 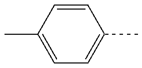 | |
| A424 | H | H | A | A | H | H | — | — | O | — | 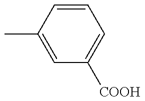 | — |
| A425 | H | H | A | A | H | H | — | — | O | — | 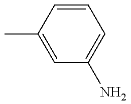 | — |
| A426 | H | H | A | A | H | H | — | — | O | — | 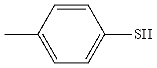 | — |
| A427 | H | H | A | A | H | H | CN | 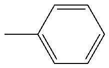 | C | — | 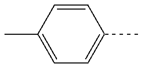 | 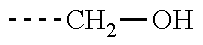 |
| A428 | H | H | A | A | H | H | 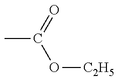 | 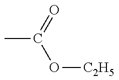 | C | — | 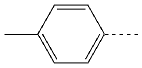 | 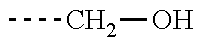 |
| A429 | H | H | H | H | H | H | A | A | C | — | — | COOH |
| A430 | H | H | H | A | H | H | CN | CN | C | — | 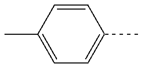 | 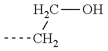 |
| A431 | H | H | 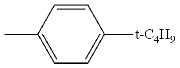 | A | H | H | 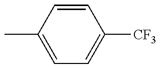 | — | N | — | 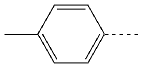 | 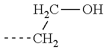 |

Specific examples of the compound represented by formula (A5) above are shown in Tables 5-1 and 5-2. In the tables, γ represents a hydrogen atom when “-” appears in the γ column and this hydrogen atom appears in the α column or the β column.

TABLE 5-1

| | | | | | | | | | | | | A | | |
|---|---|---|---|---|---|---|---|---|---|---|---|---|---|---|
| Example compound | R⁵⁰¹ | R⁵⁰² | R⁵⁰³ | R⁵⁰⁴ | R⁵⁰⁵ | R⁵⁰⁶ | R⁵⁰⁷ | R⁵⁰⁸ | R⁵⁰⁹ | R⁵¹⁰ | Z⁵⁰¹ | α | β | γ |
| A501 | H | A | H | H | H | H | H | H | CN | CN | C | — | 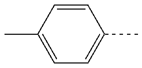 | 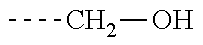 |
| A502 | H | A | H | H | H | H | H | H | CN | CN | C | — | 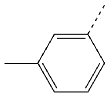 | 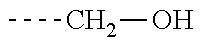 |
| A503 | H | A | H | H | H | H | H | H | CN | CN | C | — | 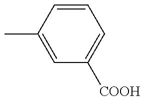 | — |
| A504 | H | A | H | H | H | H | H | H | CN | CN | C | — | 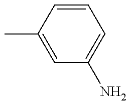 | — |
| A505 | H | A | H | H | H | H | H | H | CN | CN | C | — | 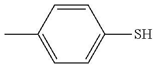 | — |
| A506 | H | NO₂ | H | H | NO₂ | H | NO₂ | H | A | — | N | — | 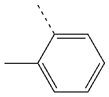 | 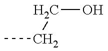 |
| A507 | H | H | H | H | H | H | H | H | A | — | N | — | 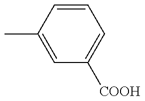 | — |
| A508 | H | H | H | H | H | H | H | H | A | — | N | — | 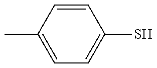 | — |
| A509 | H | H | H | H | H | H | H | H | A | — | N | 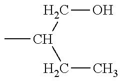 | — | — |
| A510 | CH₃ | H | H | H | H | H | H | CH₃ | A | — | N | — | 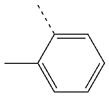 | 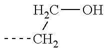 |
| A511 | H | H | Cl | H | H | Cl | H | H | A | — | N | — | 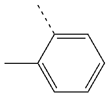 | 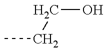 |
| A512 | H | 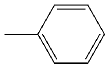 | H | H | H | H | 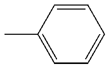 | H | A | — | N | — | 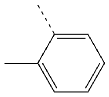 | 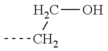 |
| A513 | H | 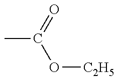 | H | H | H | H | 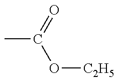 | H | A | — | N | — | 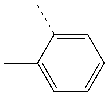 | 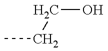 |
| A514 | H | NO₂ | H | H | NO₂ | H | NO₂ | H | A | — | N | — | 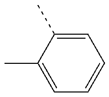 | 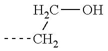 |
| A515 | H | A | H | H | H | H | A | H | CN | CN | C | — | 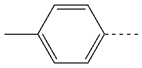 | 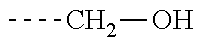 |
| A516 | H | A | H | H | H | H | A | H | CN | CN | C | — | 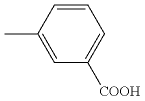 | — |

TABLE 5-2

| | | | | | | | | | | | | A | | |
|---|---|---|---|---|---|---|---|---|---|---|---|---|---|---|
| Example compound | R⁵⁰¹ | R⁵⁰² | R⁵⁰³ | R⁵⁰⁴ | R⁵⁰⁵ | R⁵⁰⁶ | R⁵⁰⁷ | R⁵⁰⁸ | R⁵⁰⁹ | R⁵¹⁰ | Z⁵⁰¹ | α | β | γ |
| A517 | H | A | H | H | H | H | A | H | CN | CN | C | — | 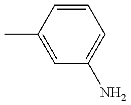 | — |
| A518 | H | A | H | H | H | H | A | H | CN | CN | C | — | 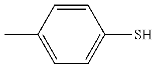 | — |
| A519 | H | A | H | H | H | H | A | H | CN | CN | C | 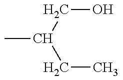 | — | — |
| A520 | H | A | H | H | H | H | A | H | CN | CN | C | 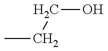 | — | — |
| A521 | H | A | H | H | H | H | A | H | CN | CN | C | — | — | COOH |
| A522 | H | A | H | H | H | H | A | H | CN | CN | C | — | — | NH2 |
| A523 | H | H | A | H | H | A | H | H | CN | CN | C | — | 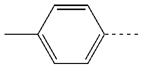 | 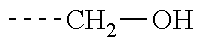 |
| A524 | H | A | H | H | H | H | A | H | — | — | O | — | 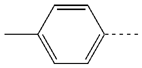 | 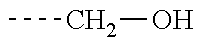 |
| A525 | H | A | H | H | H | H | A | H | — | — | O | — | 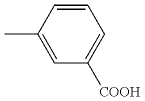 | — |
| A526 | H | A | H | H | H | H | A | H | — | — | O | — | 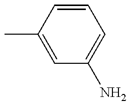 | — |
| A527 | H | A | H | H | H | H | A | H | — | — | O | — | 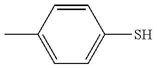 | — |
| A528 | H | A | H | H | H | H | A | H | CN | 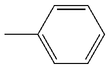 | C | — | 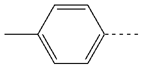 | 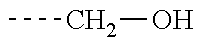 |
| A529 | H | A | H | H | H | H | A | H | 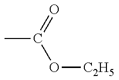 | 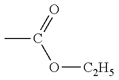 | C | — | 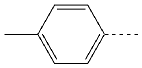 | 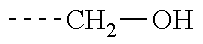 |
| A530 | H | H | H | H | H | H | H | H | A | A | C | — | — | COOH |
| A531 | H | A | H | H | H | H | A | H | CN | CN | C | — | 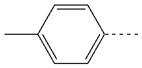 | 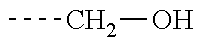 |
| A532 | H | A | H | H | H | H | — | — | 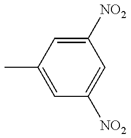 | — | N | — | 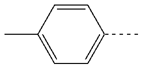 | 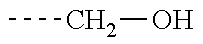 |

Specific examples of the compound represented by formula (A6) above are shown in Table 6. In the table, γ represents a hydrogen atom when “ ” appears in the γ column and this hydrogen atom appears in the α column or the β column.

TABLE 6

| | | | | | | | A | | |
|---|---|---|---|---|---|---|---|---|---|
| Example compound | R⁶⁰¹ | R⁶⁰² | R⁶³⁰ | R⁶⁰⁴ | R⁶⁰⁵ | R⁶⁰⁶ | α | β | γ |
| A601 | A | H | H | H | H | H | — | 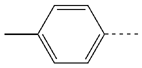 | 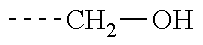 |
| A602 | A | H | H | H | H | H | — | 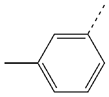 | 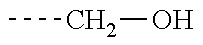 |
| A603 | A | H | H | H | H | H | — | 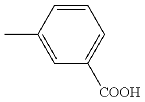 | — |
| A604 | A | H | H | H | H | H | — | 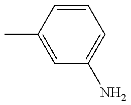 | — |
| A605 | A | H | H | H | H | H | — | 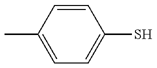 | — |
| A606 | A | H | H | H | H | H | 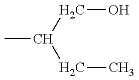 | — | — |
| A607 | A | H | H | H | H | H | 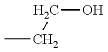 | — | — |
| A608 | A | H | H | H | H | H | — | — | COOH |
| A609 | A | H | H | H | H | H | — | — | NH2 |
| A610 | A | CN | H | H | H | H | — | — | NH2 |
| A611 | CN | CN | A | H | H | H | — | — | NH2 |
| A612 | A | H | H | H | H | H | — | — | OH |
| A613 | H | H | A | H | H | H | — | — | OH |
| A614 | CH3 | H | A | H | H | H | — | — | OH |
| A615 | H | H | A | H | H | A | — | — | OH |
| A616 | A | A | H | H | H | H | — | 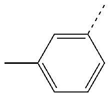 | 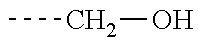 |
| A617 | A | A | H | H | H | H | 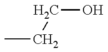 | — | — |
| A618 | A | A | H | H | H | H | 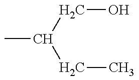 | — | — |
| A619 | A | A | H | H | H | H | — | — | COOH |

Specific examples of the compound represented by formula (A7) above are shown in Tables 7-1, 7-2, and 7-3. In the tables, γ represents a hydrogen atom when “-” appears in the γ column and this hydrogen atom appears in the α column or the β column.

TABLE 7-1

| Ex- | | | | | | | | | | | |
|---|---|---|---|---|---|---|---|---|---|---|---|
| am- | | | | | | | | | | | |
| ple | | | | | | | | | | | |
| com- | | | | | | | | | A | | |
| pound | R⁷⁰¹ | R⁷⁰² | R⁷⁰³ | R⁷⁰⁴ | R⁷⁰⁵ | R⁷⁰⁶ | R⁷⁰⁷ | R⁷⁰⁸ | α | β | γ |
| A701 | A | H | H | H | H | H | H | H | — | 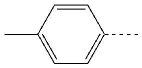 | 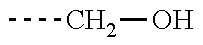 |
| A702 | A | H | H | H | H | H | H | H | — | 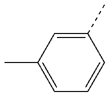 | 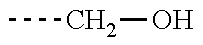 |
| A703 | A | H | H | H | H | H | H | NO₂ | — | 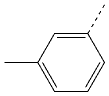 | 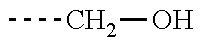 |
| A704 | A | H | H | H | H | H | H | H | — | 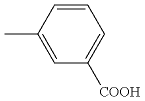 | — |
| A705 | A | H | H | H | H | H | H | H | — | 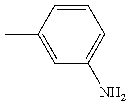 | — |
| A706 | A | H | H | H | H | H | H | H | — | 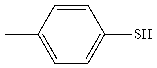 | — |
| A707 | A | H | H | H | H | H | H | H | 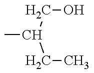 | — | — |
| A708 | A | H | H | H | H | H | H | H | — | — | COOH |
| A709 | A | H | H | H | 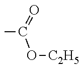 | H | H | H | — | — | COOH |
| A710 | A | H | H | H | A | H | H | H | — | 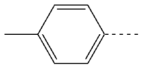 | 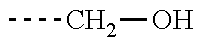 |
| A711 | A | H | H | H | A | H | H | H | — | 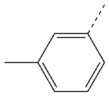 | 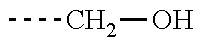 |
| A712 | A | H | H | NO₂ | A | H | H | NO₂ | — | 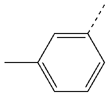 | 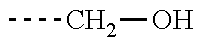 |
| A713 | A | H | F | H | A | H | F | H | — | 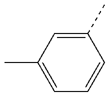 | 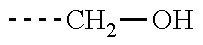 |
| A714 | A | H | H | H | A | H | H | H | — | 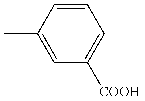 | — |
| A715 | A | H | H | H | A | H | H | H | — | 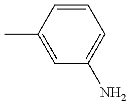 | — |

TABLE 7-2

| Example | | | | | | | | |
|---|---|---|---|---|---|---|---|---|
| compound | R⁷⁰¹ | R⁷⁰² | R⁷⁰³ | R⁷⁰⁴ | R⁷⁰⁵ | R⁷⁰⁶ | R⁷⁰⁷ | R⁷⁰⁸ |
| A716 | A | H | H | H | A | H | H | H |
| A717 | A | H | H | H | A | H | H | H |
| A718 | A | H | H | H | A | H | H | H |
| A719 | H | A | H | H | H | A | H | H |
| A720 | A | H | H | H | A | F | H | H |
| A721 | A | H | H | CH₃ | CH₃ | H | H | H |
| A722 | A | H | H | C₄H₉ | C₄H₉ | H | H | H |
| A723 | A | H | H | 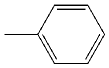 | 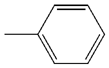 | H | H | H |
| A724 | A | H | H | CH₃ | CH₃ | H | H | H |
| A725 | A | H | H | C₄H₉ | C₄H₉ | H | H | H |
| A726 | A | H | H | 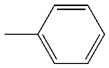 | 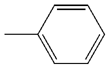 | H | H | H |
| A727 | A | H | H | C₄H₉ | C₄H₉ | H | H | H |
| A728 | A | H | H | C₄H₉ | C₄H₉ | H | H | H |
| A729 | A | H | H | C₄H₉ | C₄H₉ | H | H | H |

| Example | A | | |
|---|---|---|---|
| compound | α | β | γ |
| A716 | — | 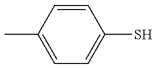 | — |
| A717 | 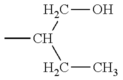 | — | — |
| A718 | — | — | COOH |
| A719 | — | — | COOH |
| A720 | — | — | COOH |
| A721 | — | — | COOH |
| A722 | — | — | COOH |
| A723 | — | — | COOH |
| A724 | — | 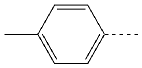 | 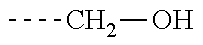 |
| A725 | — | 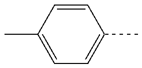 | 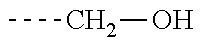 |
| A726 | — | 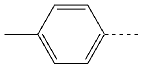 | 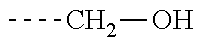 |
| A727 | — | 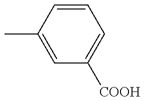 | — |
| A728 | — | 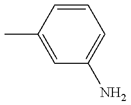 | — |
| A729 | — | 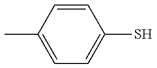 | — |

TABLE 7-3

| Example | | | | | | | | | A | | |
|---|---|---|---|---|---|---|---|---|---|---|---|
| compound | R⁷⁰¹ | R⁷⁰² | R⁷⁰³ | R⁷⁰⁴ | R⁷⁰⁵ | R⁷⁰⁶ | R⁷⁰⁷ | R⁷⁰⁸ | α | β | γ |
| A730 | A | H | H | H | A′ | H | H | H | 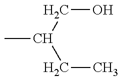 | — | — |
| A731 | A | H | H | H | A′ | H | H | H | — | 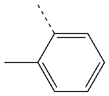 | 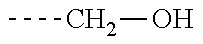 |
| A733 | A | H | H | H | A′ | H | H | H | — | 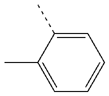 | 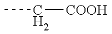 |

| Example | A′ | | |
|---|---|---|---|
| compound | α | β | γ |
| A730 | — | 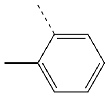 | 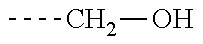 |
| A731 | 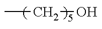 | — | — |
| A733 | 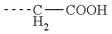 | — | — |

Specific examples of the compound represented by formula (A8) above are shown in Tables 8-1, 8-2, and 8-3. In the tables, γ represents a hydrogen atom when “-” appears in the γ column and this hydrogen atom appears in the α column or the β column.

TABLE 8-1

| | | | | | | | | | | | A | | |
|---|---|---|---|---|---|---|---|---|---|---|---|---|---|
| Example Compound | R⁸⁰¹ | R⁸⁰² | R⁸⁰³ | R⁸⁰⁴ | R⁸⁰⁵ | R⁸⁰⁶ | R⁸⁰⁷ | R⁸⁰⁸ | R⁸⁰⁹ | R⁸¹⁰ | α | β | γ |
| A801 | H | H | H | H | H | H | H | H | 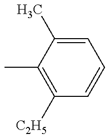 | A | 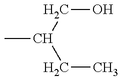 | — | — |
| A802 | H | H | H | H | H | H | H | H | 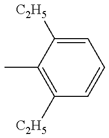 | A | 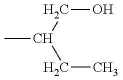 | — | — |
| A803 | H | H | H | H | H | H | H | H | 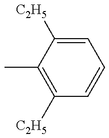 | A | — | 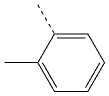 | 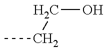 |
| A804 | H | H | H | H | H | H | H | H | 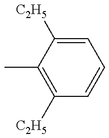 | A | — | 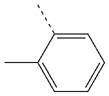 | 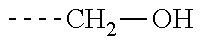 |
| A805 | H | H | H | H | H | H | H | H | 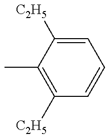 | A | — | 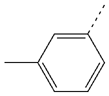 | 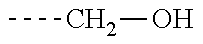 |
| A806 | H | H | H | H | H | H | H | H | 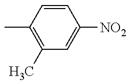 | A | 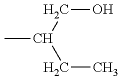 | — | — |
| A807 | H | H | H | H | H | H | H | H | 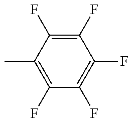 | A | 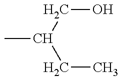 | — | — |
| A808 | H | H | H | H | H | H | H | H | 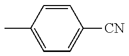 | A | 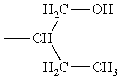 | — | — |
| A809 | H | H | H | H | H | H | H | H | 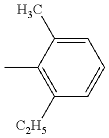 | A | —C₅H₁₀—OH | — | — |
| A810 | H | H | H | H | H | H | H | H | —C₆H₁₃ | A | 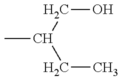 | — | — |
| A811 | H | H | H | H | H | H | H | H | 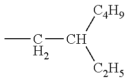 | A | — | 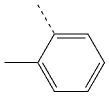 | 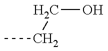 |
| A812 | H | H | H | H | H | H | H | H | 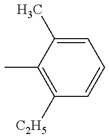 | A | — | 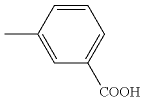 | — |
| A813 | H | H | H | H | H | H | H | H | 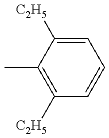 | A | — | 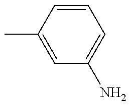 | — |
| A814 | H | H | H | H | H | H | H | H | 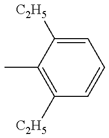 | A | — | 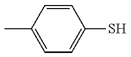 | — |
| A815 | H | H | H | H | H | H | H | H | 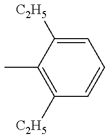 | A | — | 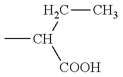 | — |

TABLE 8-2

| Ex- | | | | | | | | | | | | | |
|---|---|---|---|---|---|---|---|---|---|---|---|---|---|
| am- | | | | | | | | | | | | | |
| ple | | | | | | | | | | | | | |
| com- | | | | | | | | | | | A | | |
| pound | R⁸⁰¹ | R⁸⁰² | R⁸⁰³ | R⁸⁰⁴ | R⁸⁰⁵ | R⁸⁰⁶ | R⁸⁰⁷ | R⁸⁰⁸ | R⁸⁰⁹ | R⁸¹⁰ | α | β | γ |
| A816 | H | H | H | H | H | H | H | H | 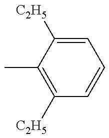 | A | — | 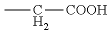 | — |
| A817 | H | H | H | H | H | H | H | H | 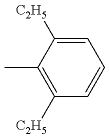 | A | — | 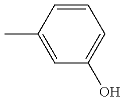 | — |
| A818 | H | H | H | H | H | H | H | H | 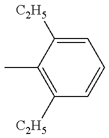 | A | — | 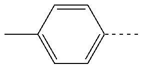 | 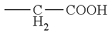 |
| A819 | H | CN | H | H | H | H | CN | H | 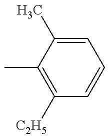 | A | 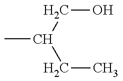 | — | — |
| A820 | H | 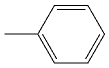 | H | H | H | H | 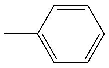 | H | 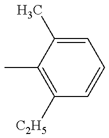 | A | 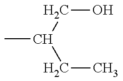 | — | — |
| A821 | H | A | H | H | H | H | H | H | 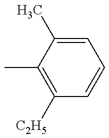 | 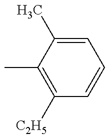 | —COOH | — | — |
| A822 | H | Cl | Cl | H | H | Cl | Cl | H | 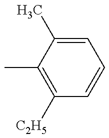 | A | 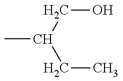 | — | — |
| A823 | H | H | H | H | H | H | H | H | 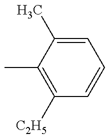 | A | 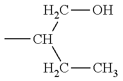 | — | — |
| A824 | H | H | H | H | H | H | H | H | A | A | 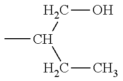 | — | — |
| A825 | H | H | H | H | H | H | H | H | A | A | — | 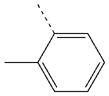 | 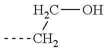 |
| A826 | H | H | H | H | H | H | H | H | A | A | — | 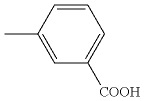 | — |
| A827 | H | H | H | H | H | H | H | H | A | A | — | 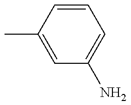 | — |
| A828 | H | H | H | H | H | H | H | H | A | A | — | 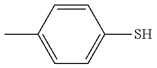 | — |
| A829 | H | H | H | H | H | H | H | H | A | A | — | 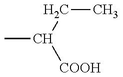 | — |
| A830 | H | H | H | H | H | H | H | H | A | A | — | 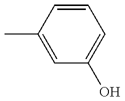 | — |
| A831 | H | 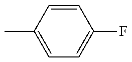 | H | H | H | H | 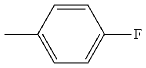 | H | 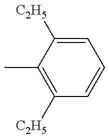 | A | — | 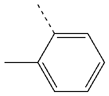 | 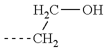 |

TABLE 8-3

| Example | | | | | | | | | | | A | | | A′ | | |
|---|---|---|---|---|---|---|---|---|---|---|---|---|---|---|---|---|
| compound | R⁸⁰¹ | R⁸⁰² | R⁸⁰³ | R⁸⁰⁴ | R⁸⁰⁵ | R⁸⁰⁶ | R⁸⁰⁷ | R⁸⁰⁸ | R⁸⁰⁹ | R⁸¹⁰ | α | β | γ | α | β | γ |
| A832 | H | H | H | H | H | H | H | H | A | A′ | 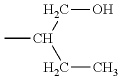 | — | — | 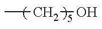 | — | — |
| A833 | H | H | H | H | H | H | H | H | A | A′ | — | 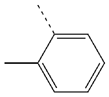 | 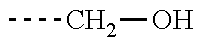 | 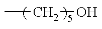 | — | — |
| A834 | H | H | H | H | H | H | H | H | A | A′ | — | 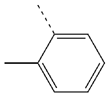 | 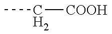 | 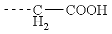 | — | — |
| A835 | H | H | H | H | H | H | H | H | A | A′ | — | 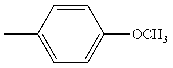 | — | 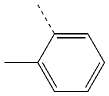 | 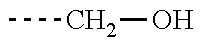 | — |

Specific examples of the compound represented by formula (A9) above are shown in Tables 9-1 and 9-2. In the tables, γ represents a hydrogen atom when “-” appears in the γ column and this hydrogen atom appears in the α column or the β column.

TABLE 9-1

| | | | | | | | | | A | | |
|---|---|---|---|---|---|---|---|---|---|---|---|
| Example compound | R⁹⁰¹ | R⁹⁰² | R⁹⁰³ | R⁹⁰⁴ | R⁹⁰⁵ | R⁹⁰⁶ | R⁹⁰⁷ | R⁹⁰⁸ | α | β | γ |
| A901 | A | H | H | H | H | H | H | H | —CH₂—OH | — | — |
| A902 | A | H | H | H | H | H | H | H | 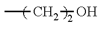 | — | — |
| A903 | A | H | H | H | 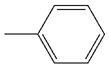 | H | H | H | 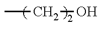 | — | — |
| A904 | A | 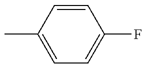 | H | H | 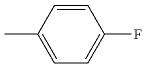 | H | H | H | 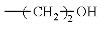 | — | — |
| A905 | A | NO₂ | H | H | H | NO₂ | H | H | 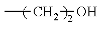 | — | — |
| A906 | A | H | H | H | H | A | H | H | 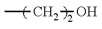 | — | — |
| A907 | A | H | H | H | A | H | H | H | 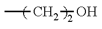 | — | — |
| A908 | A | H | H | H | A | H | H | H | — | 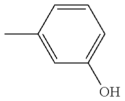 | — |
| A909 | A | H | H | A | H | H | H | H | 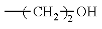 | — | — |
| A910 | A | H | H | A | H | H | H | H | — | 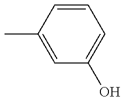 | — |
| A911 | H | H | H | H | H | H | H | A | —CH₂—OH | — | — |
| A912 | H | H | H | H | H | H | H | A | 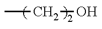 | — | — |
| A913 | H | NO₂ | H | H | H | NO₂ | H | A | 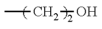 | — | — |
| A914 | H | H | H | H | H | H | H | A | — | 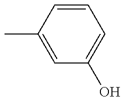 | — |
| A915 | H | H | H | H | H | H | H | A | — | 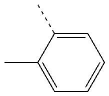 | 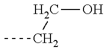 |
| A916 | H | H | H | H | H | H | H | A | — | 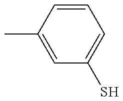 | — |
| A917 | H | H | H | H | H | H | H | A | — | 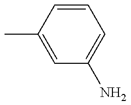 | — |
| A918 | H | H | H | H | H | H | H | A | — | 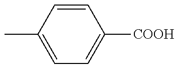 | — |
| A919 | H | CN | H | H | H | H | CN | A | — | 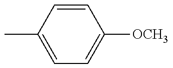 | — |
| A920 | A | A | H | H | H | H | H | H | 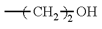 | — | — |
| A921 | A | A | H | NO₂ | H | H | NO₂ | H | 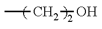 | — | — |
| A922 | H | A | A | H | H | H | H | H | — | — | OH |
| A923 | H | H | A | H | H | H | H | H | 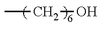 | — | — |
| A924 | H | H | A | H | H | H | H | A | — | 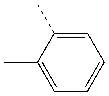 | 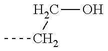 |

TABLE 9-2

| | | | | | | | | | A | | | A′ | | |
|---|---|---|---|---|---|---|---|---|---|---|---|---|---|---|
| Example compound | R⁹⁰¹ | R⁹⁰² | R⁹⁰³ | R⁹⁰⁴ | R⁹⁰⁵ | R⁹⁰⁶ | R⁹⁰⁷ | R⁹⁰⁸ | α | β | γ | α | β | γ |
| A925 | A | H | H | H | A′ | H | H | H | 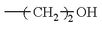 | — | — | — | 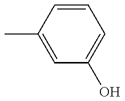 | — |
| A926 | A | H | H | A′ | H | H | H | H | 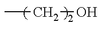 | — | — | — | 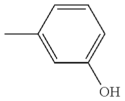 | — |
| A927 | H | A′ | H | H | H | H | H | A | 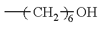 | — | — | — | 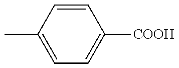 | — |

A derivative (derivative of the electron transporting substance) having the structure represented by (A1) can be synthesized by, for example, any of known synthetic methods described in U.S. Pat. Nos. 4,442,193, 4,992,349, and 5,468,583 and Chemistry of materials, Vol. 19, No. 11, 2703-2705 (2007). It can also be synthesized through a reaction between a naphthalenetetracarboxylic dianhydride and a monoamine derivative available from Tokyo Chemical Industry Co., Ltd., Sigma-Aldrich Japan K.K., and Johnson Matthey Japan Incorporated.

The compound represented by (A1) has polymerizable functional groups (a hydroxy group, a thiol group, an amino group, a carboxyl group, and a methoxy group) that can be cured (polymerized) with the amine compound. Examples of the method for introducing these polymerizable groups into the derivative having the structure (A1) include a method with which the polymerizable functional groups are directly introduced into a derivative having the structure (A1) and a method with which structures that have the polymerizable functional groups or functional groups that can serve as precursors of the polymerizable functional groups are introduced to the derivative. Examples of the latter method include a method for introducing a functional group-containing aryl group through a cross coupling reaction of a halide of a naphthylimide derivative and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide. A naphthalenetetracarboxylic dianhydride derivative or monoamine derivative having the polymerizable functional groups described above or functional groups that can serve as precursors of the polymerizable functional groups may be used as the raw material for synthesizing the naphthylimide derivative.

The derivative having the structure (A2) is available from Tokyo Chemical Industry Co., Ltd., Sigma-Aldrich Japan K.K., and Johnson Matthey Japan Incorporated, for example. The derivative having the structure (A2) can also be synthesized by synthetic methods disclosed in Chem. Educator No. 6, 227-234 (2001), Journal of Synthetic Organic Chemistry, Japan, vol. 15, 29-32 (1957), and Journal of Synthetic Organic Chemistry, Japan, vol. 15, 32-34 (1957) based on a phenanthrene derivative or a phenanthroline derivative. A dicyanomethylene group may be introduced through a reaction with a malononitrile.

The compound represented by (A2) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A2) include a method with which the polymerizable functional groups are directly introduced to the derivative having the structure (A2) and a method with which structures that have the polymerizable functional groups or functional groups that serve as precursors of the polymerizable functional groups are introduced to the derivative. Examples of the latter method include a method for introducing a functional group-containing aryl group through a cross coupling reaction of a halide of phenanthrenequinone and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

The derivative having the structure (A3) is available from Tokyo Chemical Industry Co., Ltd., Sigma-Aldrich Japan K.K., and Johnson Matthey Japan Incorporated, for example. The derivative having the structure (A3) can also be synthesized by a synthetic method disclosed in Bull. Chem. Soc. Jpn., Vol. 65, 1006-1011 (1992), based on a phenanthrene derivative or a phenanthroline derivative. A dicyanomethylene group may be introduced through a reaction with a malononitrile.

The compound represented by (A3) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A3) include a method with which the polymerizable functional groups are directly introduced to the derivative having the structure (A3) and a method with which structures that have the polymerizable functional groups or functional groups that serve as precursors of the polymerizable functional groups are introduced to the derivative. Examples of the latter method include a method for introducing a functional group-containing aryl group through a cross coupling reaction of a halide of phenanthrolinequinone and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

The derivative having the structure (A4) is available from Tokyo Chemical Industry Co., Ltd., Sigma-Aldrich Japan K.K., and Johnson Matthey Japan Incorporated, for example. The derivative having the structure (A4) can also be synthesized by synthetic methods disclosed in Tetrahedron Letters, 43 (16), 2991-2994 (2002) and Tetrahedron Letters, 44 (10), 2087-2091 (2003), based on an acenaphthenequinone derivative. A dicyanomethylene group may be introduced through a reaction with a malononitrile.

The compound represented by (A4) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A4) include a method with which the polymerizable functional groups are directly introduced to the derivative having the structure (A4) and a method with which structures that have the polymerizable functional groups or functional groups that serve as precursors of the polymerizable functional groups are introduced to the derivative. Examples of the latter method include a method for introducing a functional group-containing aryl group through a cross coupling reaction of a halide of acenaphthenequinone and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

The derivative having the structure (A5) is available from Tokyo Chemical Industry Co., Ltd., Sigma-Aldrich Japan K.K., and Johnson Matthey Japan Incorporated, for example. The derivative having the structure (A5) can also be synthesized by a synthetic method disclosed in U.S. Pat. No. 4,562,132 by using a fluorenone derivative and malononitrile. Alternatively, the derivative may be made by synthetic methods disclosed in Japanese Patent Laid-Open Nos. 5-279582 and 7-70038 by using a fluorenone derivative and an aniline derivative.

The compound represented by (A5) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A5) include a method with which the polymerizable functional groups are directly introduced to the derivative having the structure (A5) and a method with which structures that have the polymerizable functional groups or functional groups that serve as precursors of the polymerizable functional groups are introduced to the derivative. Examples of the latter method include a method for introducing a functional group-containing aryl group through a cross coupling reaction of a halide of fluorenone and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

The derivative having the structure (A6) can be synthesized by, for example, synthetic methods disclosed in Chemistry Letters, 37 (3), 360-361 (2008) and Japanese Patent Laid-Open No. 9-151157. The derivative having the structure (A6) is also available from Tokyo Chemical Industry Co., Ltd., Sigma-Aldrich Japan K.K., and Johnson Matthey Japan Incorporated, for example.

The compound represented by (A6) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A6) include a method with which structures that have the polymerizable functional groups or functional groups that serve as precursors of the polymerizable functional groups are introduced to a naphthoquinone derivative. Examples of this method include a method for introducing a functional group-containing aryl group through a cross coupling reaction of a halide of naphthoquinone and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

The derivative having the structure (A7) can be synthesized by, for example, synthetic methods disclosed in Japanese Patent Laid-Open No. 1-206349 and PPCI/Japan Hard Copy '98 Proceedings, p. 207 (1998). For example, synthesis may be conducted by using, as a raw material, a phenol derivative available from Tokyo Chemical Industry Co., Ltd., or Sigma-Aldrich Japan K.K.

The compound represented by (A7) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A7) include a method with which structures that have the polymerizable functional groups or functional groups that serve as precursors of the polymerizable functional groups are introduced to the derivative. Examples of this method include a method for introducing a functional group-containing aryl group through a cross coupling reaction of a halide of diphenoquinone and a base in the presence of a palladium catalyst, a method for introducing a functional group-containing alkyl group through a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

The derivative having the structure (A8) can be synthesized by, for example, a known synthetic method disclosed in Journal of the American chemical society, Vol. 129, No. 49, 15259-78 (2007). The derivative can also be synthesized through a reaction between a perylenetetracarboxylic dianhydride and a monoamine derivative available from Tokyo Chemical Industry Co., Ltd., Sigma-Aldrich Japan K.K., and Johnson Matthey Japan Incorporated.

The compound represented by (A8) has polymerizable functional groups (a hydroxy group, a thiol group, an amino group, a carboxyl group, and a methoxy group) that can polymerize with the amino compound. Examples of the method for introducing these polymerizable functional groups into the derivative having the structure (A8) include a method with which the polymerizable functional groups are directly introduced to the derivative having the structure (A8) and a method with which structures that have the polymerizable functional groups or functional groups that serve as precursors of the polymerizable functional groups are introduced to the derivative. Examples of the latter method include a method including performing a cross coupling reaction of a halide of a perylene imide derivative and a base in the presence of a palladium catalyst and a method including performing a cross coupling reaction between the halide and a base in the presence of an FeCl₃ catalyst. A perylenetetracarboxylic dianhydride derivative or monoamine derivative having the polymerizable functional groups or functional groups that can serve as precursors of the polymerizable functional groups can be used as a raw material for synthesizing the perylene imide derivative.

The derivative having the structure (A9) is available from Tokyo Chemical Industry Co., Ltd., Sigma-Aldrich Japan K.K., and Johnson Matthey Japan Incorporated, for example.

The compound represented by (A9) has polymerizable functional groups (a hydroxy group, a thiol group, an amino group, a carboxyl group, and a methoxy group) that can polymerize with the amine compound. Examples of the method for introducing these polymerizable functional groups into the derivative having the structure (A9) include a method with which structures having the polymerizable functional groups or functional groups that can serve as the precursors of the polymerizable functional groups are introduced to a commercially available anthraquinone derivative. Examples of this method include a method for introducing a functional group-containing aryl group through a cross coupling reaction between a halide of anthraquinone and a base in the presence of a palladium catalyst, a method including performing a cross coupling reaction between the halide and a base in the presence of an FeCl₃ catalyst, and a method for introducing a hydroxyalkyl group or a carboxyl group through allowing an epoxy compound, CO₂, or the like to act on a lithiated halide.

### Amine Compound

Provided below is a description of the at least one compound selected from the group consisting of a compound represented by formula (C1), an oligomer of a compound represented by formula (C1), a compound represented by formula (C2), an oligomer of a compound represented by formula (C2), a compound represented by formula (C3), an oligomer of a compound represented by formula (C3), a compound represented by formula (C4), an oligomer of a compound represented by formula (C4), a compound represented by formula (C5), and an oligomer of a compound represented by formula (C5).

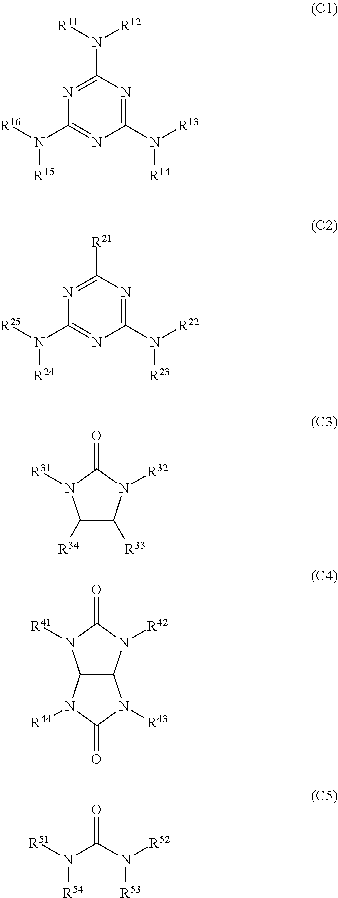

In formulae (C1) to (C5), R¹¹ to R¹⁶, R²² to R²⁵, R³¹ to R³⁴, R⁴¹ to R⁴⁴, and R⁵¹ to R⁵⁴ each independently represents a hydrogen atom, a hydroxyl group, an acyl group, or a monovalent group represented by —CH₂—OR¹; at least one of R¹¹ to R¹⁶, at least one of R²² to R²⁵, at least one of R³¹ to R³⁴, at least one of R⁴¹ to R⁴⁴, and at least one of R⁵¹ to R⁵⁴ each represents a monovalent group represented by —CH₂—OR¹; and R¹-represents a hydrogen atom or an alkyl group having 1 to 10 carbon atoms. The alkyl group may be a methyl group, an ethyl group, a propyl group (n-propyl group or isopropyl group), or a butyl group (n-butyl group, an isobutyl group, or a tert-butyl group) from the viewpoint of polymerizability. R²¹ represents an aryl group, an aryl group substituted with an alkyl group, a cycloalkyl group, or a cycloalkyl group substituted with an alkyl group.

In formulae (C1) to (C5), at least three of R¹¹ to R¹⁶, at least three of R²² to R²⁵, at least three of R³¹ to R³⁴, at least three of R⁴¹ to R⁴⁴, and at least three of R⁵¹ to R⁵⁴ more preferably each represents a monovalent group represented by —CH₂—OR¹.

Specific examples of the compounds represented by formulae (C1) to (C5) above are shown below.

The amine compound may contain oligomers of the compounds represented by formulae (C1) to (C5). From the viewpoint of obtaining the even polymer film described above, the amine compound may contain 10 mass % or more of the compounds (monomers) represented by (C1) to (C5) on a mass basis.

The degree of polymerization of the oligomers may be 2 or more and 100 or less. The oligomers and the monomers described above may be used alone or in combination as a mixture of two or more.

The molecular weight of the amine compound is more preferably 150 or more and 1000 or less and most preferably 180 or more and 560 or less since the evenness of the undercoat layer is enhanced and the positive ghosting suppressing effect is achieved.

Examples of the commercially available products of the compound represented by formula (C1) include SUPER MELAMI No. 90 (produced by NOF Corporation), SUPER BECKAMINE (registered trademark) TD-139-60, L-105-60, L127-60, L110-60, J-820-60, and G-821-60 (produced by DIC Corporation), U-VAN 2020 (produced by Mitsui Chemicals, Inc.), Sumitex Resin M-3 (produced by Sumitomo Chemical Co., Ltd.), and NIKALAC MW-30, MW-390, and MX-750LM (produced by Nippon Carbide Industries Co., Inc.). Examples of the commercially available products of the compound represented by formula (C2) include SUPER BECKAMINE (registered trademark) L-148-55, 13-535, L-145-60, and TD-126 (produced by DIC Corporation) and NIKALAC BL-60 and BX-4000 (produced by Nippon Carbide Industries Co., Inc.). Examples of the commercially available products of the compound represented by formula (C3) include NIKALAC MX-280 (produced by Nippon Carbide Industries Co., Inc.). Examples of the commercially available products of the compound represented by formula (C4) include NIKALAC MX-270 (produced by Nippon Carbide Industries Co., Inc.). Examples of the commercially available products of the compound represented by formula (C5) include NIKALAC MX-290 (produced by Nippon Carbide Industries Co., Inc.).

Specific examples of the compound represented by formula (C1) are as follows.

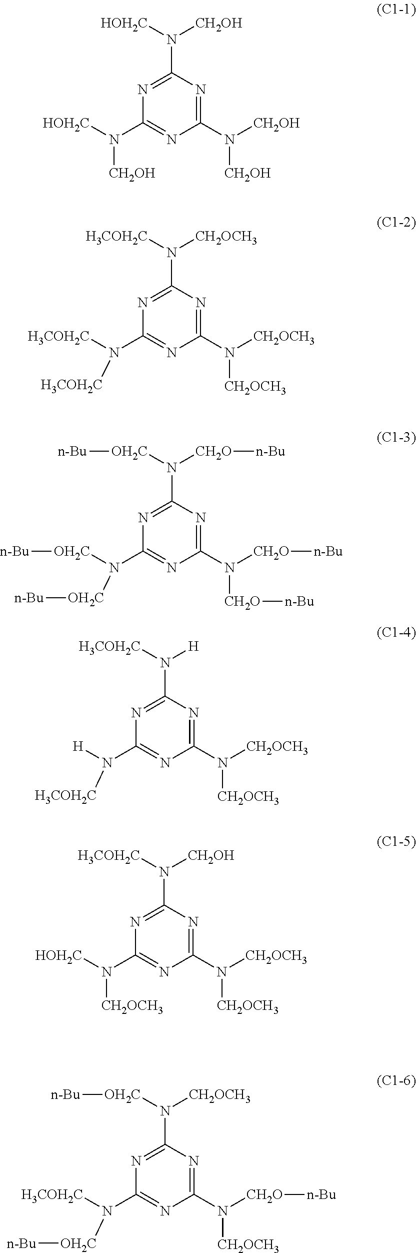

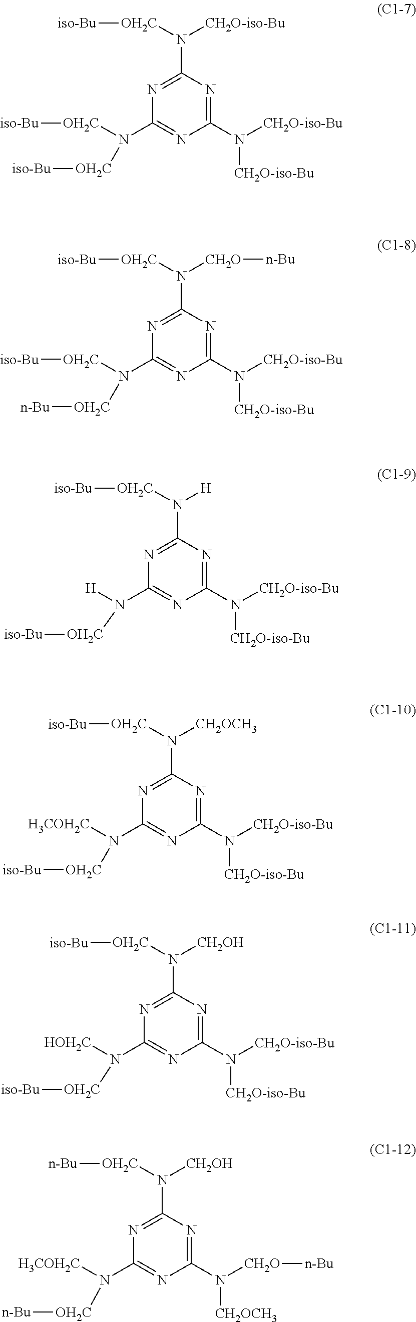

Specific examples of the compound represented by formula (C2) are as follows.

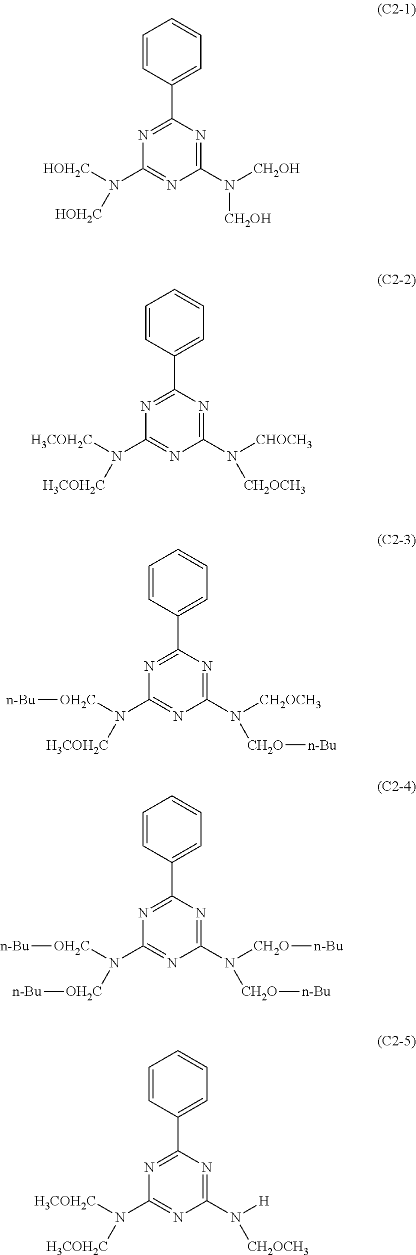

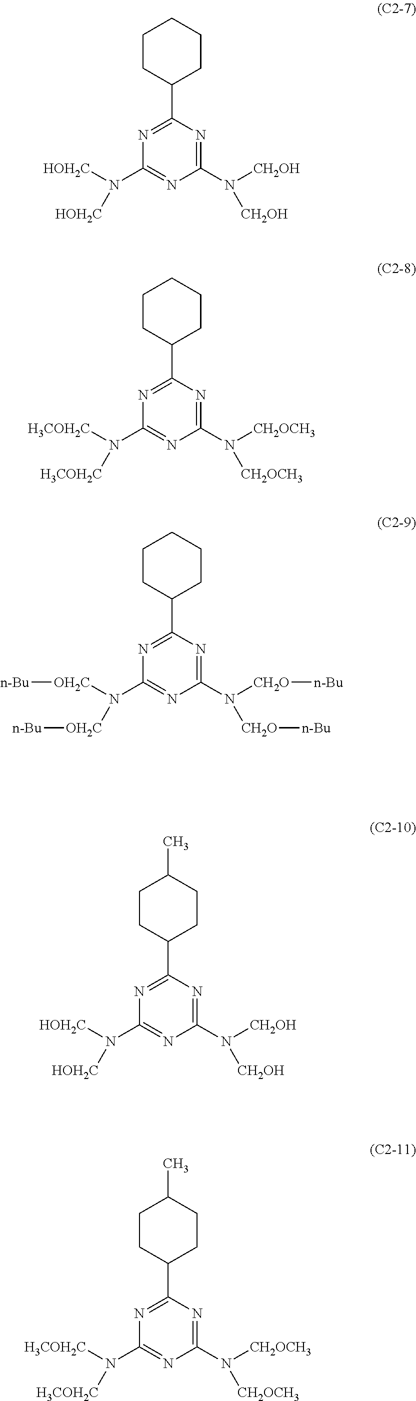

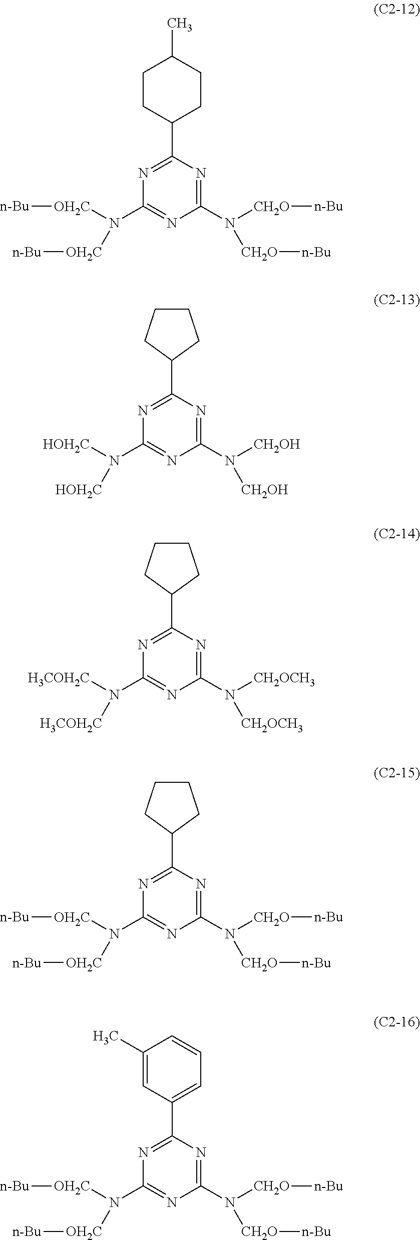

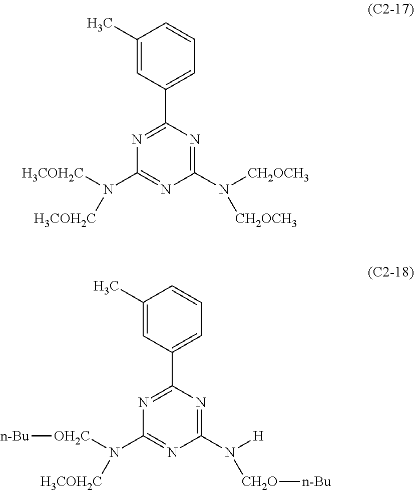

Specific examples of the compound represented by formula (C3) are as follows.

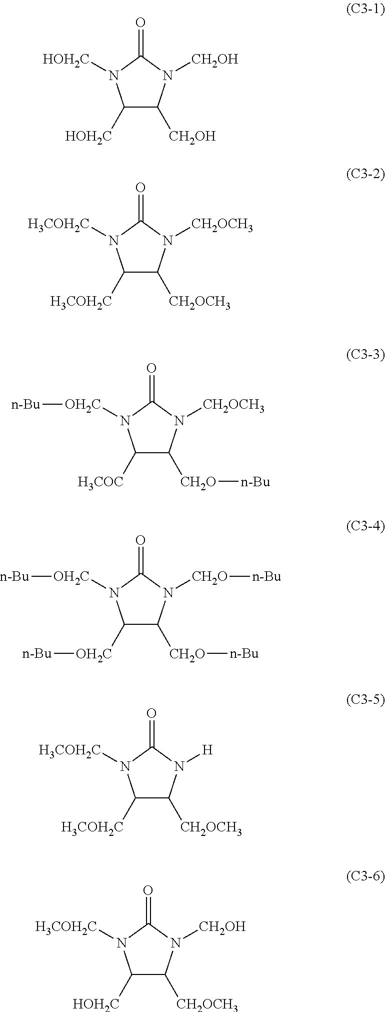

Specific examples of the compound represented by formula (C4) are as follows.

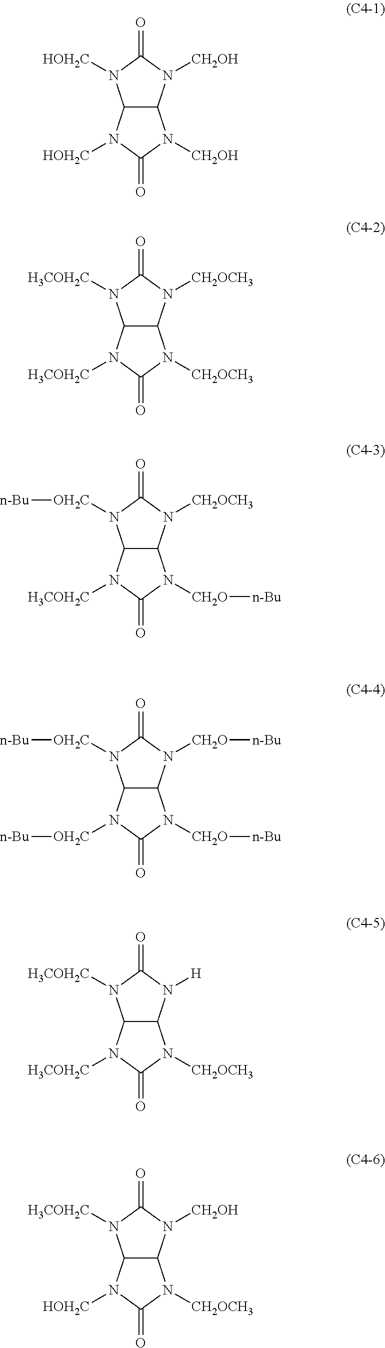

Specific examples of the compound represented by formula (C5) are as follows.

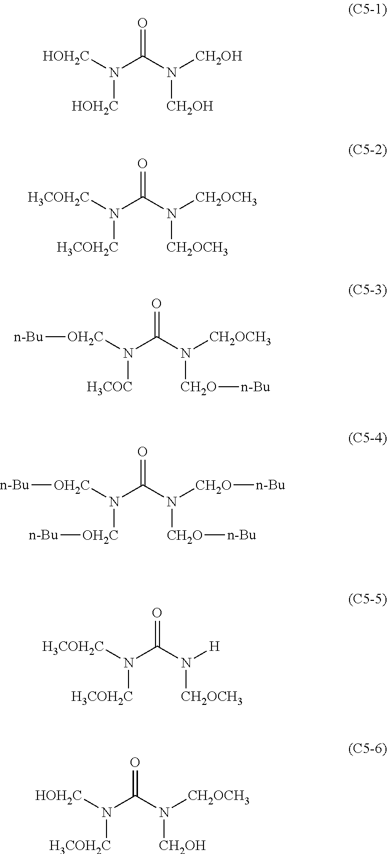

### Resin

The resin having a repeating structural unit represented by formula (B) above (this resin may also be referred to as “resin B” hereinafter) is described. The resin having a repeating structural unit represented by formula (B) is obtained by, for example, polymerizing a monomer that has polymerizable functional groups (a hydroxy group, a thiol group, an amino group, a carboxyl group, and a methoxy group) available from Sigma-Aldrich Japan K.K. and Tokyo Chemical Industry Co., Ltd.

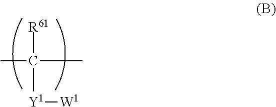

In formula (B), R⁶¹ represents a hydrogen atom or an alkyl group; Y¹ represents a single bond, an alkylene group, or a phenylene group; and W¹ represents a hydroxy group, a thiol group, an amino group, a carboxyl group, or a methoxy group.

The resin may be commercially purchased. Examples of the commercially available resin include polyether polyol resins such as AQD-457 and AQD-473 produced by Nippon Polyurethane Industry Co., Ltd., and SANNIX GP-400 and GP-700 produced by Sanyo Chemical Industries, Ltd., polyester polyol resins such as PHTHALKYD W2343 produced by Hitachi Chemical Co., Ltd., WATERSOL S-118 and CD-520 and BECKOLITE M-6402-50 and M-6201-401M produced by DIC Corporation, HARIDIP WH-1188 produced by Harima Chemicals Group, Inc., and ES3604 and ES6538 produced by Japan U-PiCA Company, Ltd., polyacryl polyol resins such as BURNOCK WE-300 and WE-304 produced by DIC Corporation, polyvinyl alcohol resins such as Kuraray POVAL PVA-203 produced by Kuraray Co., Ltd., polyvinyl acetal resins such BX-1, BM-1, KS-1, and KS-5 produced by Sekisui Chemical Co., Ltd., polyamide resins such as TORESIN FS-350 produced by Nagase Chemtex Corporation, carboxyl group-containing resins such as AQUALIC produced by Nippon Shokubai Co., Ltd., and FINLEX SG2000 produced by Namariichi Co., Ltd., polyamines such as LUCKAMIDE produced by DIC Corporation, and polythiol resins such as QE-340M produced by Toray Industries Inc. Among these, polyvinyl acetal resins and polyester polyol resins are preferred from the viewpoints of evenness of the undercoat layer.

The weight-average molecular weight (Mw) of the resin B is preferably in the range of 5,000 or more and 400,000 or less and more preferably in the range of 5,000 or more and 300,000 or less. The reason for this is presumably as follows. When the polymerizable functional group (a monovalent group represented by —CH₂—OR¹) of the amine compound described above is polymerized (crosslinked) with the resin B, aggregation of the molecular chains of the resin B is suppressed, thus localization of the amine compound is suppressed, and the electron transporting substance segments are evenly distributed in the undercoat layer without being localized.

Examples of the method for determining the quantity of the polymerizable functional group in the resin include a carboxyl group titration with potassium hydroxide, an amino group titration with sodium nitrite, a hydroxy group titration with acetic anhydride and potassium hydroxide, a thiol group titration with 5,5′-dithiobis(2-nitrobenzoic acid), and a calibration curve method that uses an IR spectrum of samples with varying polymerizable functional group introduction ratios.

Specific examples of the resin B are as follows.

TABLE 10

| Resin | Structure | | | Other | Molecular |
|---|---|---|---|---|---|
| type | R⁶¹ | Y¹ | W¹ | segment | weight |
| B1 | H | Single bond | OH | Butyral | 1 × 10⁵ |
| B2 | H | Single bond | OH | Butyral | 4 × 10⁴ |
| B3 | H | Single bond | OH | Butyral | 2 × 10⁴ |
| B4 | H | Single bond | OH | Polyolefin | 1 × 10⁵ |
| B5 | H | Single bond | OH | Ester | 8 × 10⁴ |
| B6 | H | Single bond | OH | Polyether | 5 × 10⁴ |
| B7 | H | Single bond | OH | Cellulose | 3 × 10⁴ |
| B8 | H | Single bond | COOH | Polyolefin | 6 × 10⁴ |
| B9 | H | Single bond | NH₂ | Polyamide | 2 × 10⁵ |
| B10 | H | Single bond | SH | Polyolefin | 9 × 10³ |
| B11 | H | Phenylene | OH | Polyolefin | 4 × 10³ |
| B12 | H | Single bond | OH | Butyral | 7 × 10⁴ |
| B13 | H | Single bond | OH | Polyester | 2 × 10⁴ |
| B14 | H | Single bond | OH | Polyester | 6 × 10³ |
| B15 | H | Single bond | OH | Polyester | 8 × 10⁴ |
| B16 | H | Single bond | COOH | Polyolefin | 2 × 10⁵ |
| B17 | H | Single bond | COOH | Polyester | 9 × 10³ |
| B18 | H | Single bond | COOH | Polyester | 8 × 10² |
| B19 | CH₃ | Alkylene | OH | Polyester | 2 × 10⁴ |
| B20 | C₂H₅ | Alkylene | OH | Polyester | 1 × 10⁴ |
| B21 | C₂H₅ | Alkylene | OH | Polyester | 5 × 10⁴ |
| B22 | H | Single bond | OCH₃ | Polyolefin | 7 × 10³ |
| B23 | H | Single bond | OH | Butyral | 2.7 × 10⁵ |
| B24 | H | Single bond | OH | Butyral | 4 × 10⁵ |
| B25 | H | Single bond | OH | Acetal | 3.4 × 10⁵ |

The ratio of the functional group (a monovalent group represented by —CH₂—OR¹) of the amine compound to the total of the polymerizable functional groups of the resin and the polymerizable functional groups of the electron transporting substance may be 1:0.5 to 1:3.0 since the percentage of the functional groups reacted increases.

The compounds of the present invention etc., were characterized by the following methods.

### Mass Spectroscopy (MS)

The molecular weight was measured with a mass spectrometer (MALDI-TOF MS, ultraflex produced by Bruker Daltonics K.K.) at an acceleration voltage of 20 kV in reflector mode with fullerene C60 as a molecular weight standard. The peak top value observed was confirmed.

### Nuclear Magnetic Resonance (NMR) Analysis

The structure was confirmed through ¹H-NMR and ¹³C-NMR analysis (FT-NMR, JNM-EX400 model produced by JEOL Ltd.) in 1,1,2,2-tetrachloroethane (d2) or dimethyl sulfoxide (d6) at 120° C.

### Gel Permeation Chromatography (GPC)

GPC was conducted with a gel permeation chromatograph HLC-8120 produced by Tosoh Corporation using polystyrene standards.

A coating solution for an undercoat layer containing the amine compound, the resin B, and the electron transporting substance was applied to an aluminum sheet by using a Mayer bar. The resulting coating film was dried by heating at 160° C. for 40 minutes to form an undercoat layer.

The undercoat layer was immersed in a cyclohexanone/ethyl acetate (1:1) mixed solvent for 2 minutes and dried at 160° C. for 5 minutes. The weight of the undercoat layer was measured before and after the immersion. In Examples, that the elution of the components in the undercoat layer did not occur by the immersion was confirmed (the weight difference within the range of ±2%). It was found that, according to Examples of the invention, the elution did not occur and the undercoat layer was cured (polymerized).

### Support

The support may have electrical conductivity (conductive support). For example, the support may be composed of a metal such as aluminum, nickel, copper, gold, or iron or an alloy. Other examples of the support include those prepared by forming a thin film of a metal such as aluminum, silver, or gold, or a thin film of a conductive material such as indium oxide or tin oxide on an insulating support such as one composed of a polyester resin, a polycarbonate resin, a polyimide resin, or glass.

The surface of the support may be subjected to an electrochemical treatment such as anodizing, a wet horning treatment, a blasting treatment, or a cutting treatment to improve the electrical properties and suppress interference fringes.

A conductive layer may be interposed between the support and the undercoat layer described below. The conductive layer is obtained by forming a coating film on a support by using a coating solution containing a resin and conductive particles dispersed in the resin and drying the coating film. Examples of the conductive particles include carbon black, acetylene black, metal powders such as aluminum, nickel, iron, nichrome, copper, zinc, and silver powders, and metal oxide powders such as conductive tin oxide and indium tin oxide (ITO).

Examples of the resin include polyester resins, polycarbonate resins, polyvinyl butyral resins, acrylic resins, silicone resins, epoxy resins, melamine resins, urethane resins, phenolic resins, and alkyd resins.

Examples of the solvent used for preparing the coating solution for forming the conductive layer include ether-based solvents, alcohol-based solvents, ketone-based solvents, and aromatic hydrocarbon solvents. The thickness of the conductive layer is preferably 0.2 μm or more and 40 μm or less, more preferably 1 μm or more and 35 μm or less, and most preferably 5 μm or more and 30 μm or less.

### Photosensitive Layer

A photosensitive layer is formed on the undercoat layer.

Examples of the charge generating substance include azo pigments, perylene pigments, anthraquinone derivatives, anthanthrone derivative, dibenzpyrenequinone derivatives, pyranthrone derivatives, violanthrone derivatives, isoviolanthrone derivatives, indigo derivatives, thioindigo derivatives, phthalocyanine pigments such as metal phthalocyanine and metal-free phthalocyanine, and bisbenzimidazole derivatives. Among these, azo pigments and phthalocyanine pigments are preferable. Among phthalocyanine pigments, oxytitanium phthalocyanine, chlorogallium phthalocyanine, and hydroxygallium phthalocyanine are preferable.

The photosensitive layer may be a layered photosensitive layer. In such a case, examples of the binder resin used in the charge generating layer include polymers and copolymers of vinyl compounds such as styrenes, vinyl acetate, vinyl chloride, acrylates, methacrylates, vinylidene fluoride, and trifluoroethylene, polyvinyl alcohol resins, polyvinyl acetal resins, polycarbonate resins, polyester resins, polysulfone resins, polyphenylene oxide resins, polyurethane resins, cellulose resins, phenolic resins, melamine resins, silicon resins, and epoxy resins. Among these, polyester resins, polycarbonate resins, and polyvinyl acetal resins are preferred and polyvinyl acetal resins are more preferred.

The ratio of the charge generating substance to the binder resin in the charge generating layer (charge generating substance/binder resin) is preferably in the range of 10/1 to 1/10 and more preferably in the range of 5/1 to 1/5. Examples of the solvent used for preparing the coating solution for forming the charge generating layer include alcohol-based solvents, sulfoxide-based solvents, ketone-based solvents, ether-based solvents, ester-based solvents, and aromatic hydrocarbon solvents.

The thickness of the charge generating layer may be 0.05 μm or more and 5 μm or less.

Examples of the hole transporting substance include polycyclic aromatic compounds, heterocyclic compounds, hydrazone compounds, styryl compounds, benzidine compounds, triarylamine compounds, and triphenylamine; and polymers that have a main chain or side chain containing a group derived from any of these compounds.

In the cases where the photosensitive layer is a layered photosensitive layer, the binder resin used in the charge transport layer (hole transport layer) may be a polyester resin, a polycarbonate resin, a polymethacrylate resin, a polyarylate resin, a polysulfone resin, or a polystyrene resin, for example. The binder resin is more preferably a polycarbonate resin or a polyarylate resin. The weight-average molecular weight (Mw) of the resin may be in the range of 10,000 to 300,000.

The ratio of the hole transporting substance to the binder resin in the charge transport layer (hole transporting substance/binder resin) is preferably in the range of 10/5 to 5/10 and more preferably in the range of 10/8 to 6/10. The thickness of the charge transport layer may be 5 μm or more and 40 μm or less. Examples of the solvent used in the coating solution for forming a charge transport layer include alcohol-based solvents, sulfoxide-based solvents, ketone-based solvents, ether-based solvents, ester-based solvents, and aromatic hydrocarbon solvents.

Another layer, such as a second undercoat layer, that does not contain the polymerized product of the present invention may be interposed between the support and the undercoat layer or between the undercoat layer and the photosensitive layer.

A protective layer (surface protecting layer) that contains conductive particles or a charge transporting substance and a binder resin may be provided on the photosensitive layer (charge transport layer). The protective layer may further contain additives such as a lubricant. Electrical conductivity or a hole transport property may be imparted to the binder resin of the protective layer. In such a case, there is no need to add conductive particles or a hole transporting substance other than the resin to the protective layer. The binder resin in the protective layer may be a thermoplastic resin or a curable resin curable with heat, light, or radiation (such as an electron beam).

The layers, such as an undercoat layer, a charge generating layer, and a charge transport layer, that constitute the electrophotographic photosensitive member may be formed by dissolving and/or dispersing materials constituting the respective layers in respective solvents to obtain coating solutions, applying the coating solutions, and drying and/or curing the applied coating solutions. Examples of the method used for applying the coating solutions include a dip coating method, a spray coating method, a curtain coating method, and a spin coating method. Among these, a dip coating method is preferable from the viewpoints of efficiency and productivity.

### Process Cartridge and Electrophotographic Apparatus

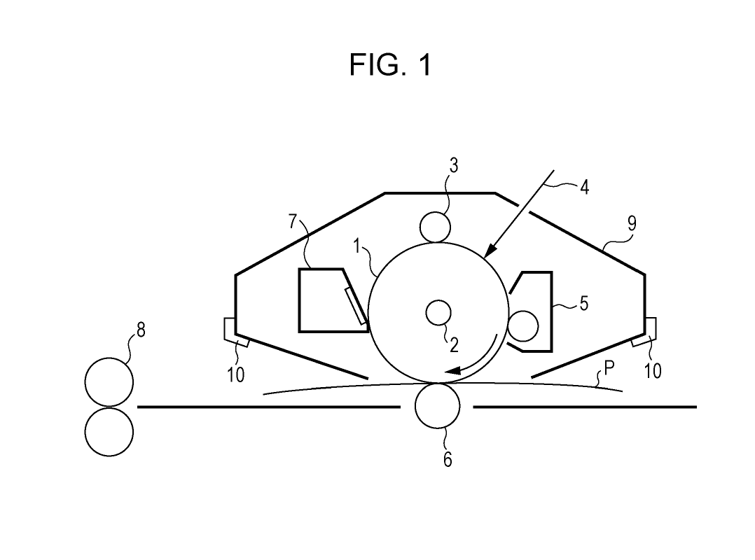

FIG. 1 is a schematic diagram of an electrophotographic apparatus that includes a process cartridge that includes an electrophotographic photosensitive member.

Referring to FIG. 1, an electrophotographic photosensitive member 1 has a cylindrical shape and is rotated about a shaft 2 in the arrow direction at a particular peripheral speed. The surface (peripheral surface) of the electrophotographic photosensitive member 1 rotated is evenly charged to a particular positive or negative potential with a charging device 3 (a primary charging device such as a charging roller). Then the surface is exposed to exposure light (image exposure light) 4 from an exposure device (not shown) through, for example, slit exposure or laser beam scanning exposure. As a result, an electrostatic latent image corresponding to a desired image is formed on the surface of the electrophotographic photosensitive member 1.

The electrostatic latent image formed on the surface of the electrophotographic photosensitive member 1 is developed with a toner contained in a developing gent in a developing device 5 and forms a toner image. The toner image on the surface of the electrophotographic photosensitive member 1 is transferred to a transfer material (such as paper) P due to a transfer bias from a transferring device (such as transfer roller) 6. The transfer material P is picked up from a transfer material feeding unit (not shown in the drawing) and fed to the nip (contact portion) between the electrophotographic photosensitive member 1 and the transferring device 6 in synchronization with the rotation of the electrophotographic photosensitive member 1.

The transfer material P that received the transfer of the toner image is detached from the surface of the electrophotographic photosensitive member 1 and guided to a fixing unit 8 where the image is fixed. An image product (a print or a copy) is output from the apparatus.

The surface of the electrophotographic photosensitive member 1 after the transfer of the toner image is cleaned with a cleaning device (such as a cleaning blade) 7 to remove the developing agent (toner) that remains after the transfer. Then the charge is erased with pre-exposure light (not shown in the drawing) from a pre-exposure device (not shown in the drawing) so that the electrophotographic photosensitive member 1 can be repeatedly used for forming images. When the charging device 3 is of a contact-charging type such as a charging roller as shown in FIG. 1, the pre-exposure is not always necessary.

Two or more selected from the electrophotographic photosensitive member 1, the charging device 3, the developing device 5, the transferring device 6, the cleaning device 7, etc., may be housed in a container so as to form a process cartridge and the process cartridge may be configured to be removably loadable to the main unit of an electrophotographic apparatus such as a copy machine or a laser beam printer. In FIG. 1, the electrophotographic photosensitive member 1, the charging device 3, the developing device 5, and the cleaning device 7 are integrally supported to form a cartridge 9 which is detachably attachable to the main unit of the electrophotographic apparatus through a guiding unit 10 such as a rail of the main body of the electrophotographic apparatus.

### EXAMPLES

The present invention will now be described in further detail through Examples. Note that the “parts” used in Examples means “parts by mass”. First, synthetic examples of the electron transporting substances according to the present invention are described.

### Synthetic Example 1

To 200 parts of dimethylacetamide, 5.4 parts of a naphthalenetetracarboxylic dianhydride (produced by Tokyo Chemical Industry Co., Ltd.), 4 parts of 2-methyl-6-ethyl aniline, and 3 parts of 2-amino-1-butanol were added in a nitrogen atmosphere and stirring was conducted at room temperature for 1 hour to prepare a solution. The solution prepared was refluxed for 8 hours. Precipitates were filtered out and recrystallized in ethyl acetate. As a result, 1.0 part of compound A101 was obtained.

### Synthetic Example 2

To 200 parts of dimethylacetamide, 5.4 parts of a naphthalenetetracarboxylic dianhydride (produced by Tokyo Chemical Industry Co., Ltd.) and 5 parts of 2-aminobutyric acid (produced by Tokyo Chemical Industry Co., Ltd.) were added in a nitrogen atmosphere and stirring was conducted at room temperature for 1 hour to prepare a solution. The solution prepared was refluxed for 8 hours. Precipitates were filtered out and recrystallized in ethyl acetate. As a result, 4.6 parts of compound A128 was obtained.

### Synthetic Example 3

To 200 parts of dimethylacetamide, 5.4 parts of a naphthalenetetracarboxylic dianhydride, 4.5 parts of 2,6-diethyl aniline (produced by Tokyo Chemical Industry Co., Ltd.), and 4 parts of 4-aminobenzenethiol were added in a nitrogen atmosphere and stirring was conducted at room temperature for 1 hour to prepare a solution. The solution prepared was refluxed for 8 hours. Precipitates were filtered out and recrystallized in ethyl acetate. As a result, 1.3 parts of compound A114 was obtained.

### Synthetic Example 4

In accordance with a synthetic method described in Chem. Educator No. 6, 227-234 (2001), 7.4 parts of 3,6-dibromo-9,10-phenanthrenedione was synthesized from 2.8 parts of 4-(hydroxymethyl)phenyl boric acid (produced by Aldrich) and phenanthrenequinone (produced by Sigma-Aldrich Japan) in a nitrogen atmosphere. To a mixed solvent containing 100 parts of toluene and 50 parts of ethanol, 7.4 parts of 3,6-dibromo-9,10-phenanthrenedione was added and 100 parts of a 20% aqueous sodium carbonate solution was added dropwise to the resulting mixture. Then 0.55 parts of tetrakis(triphenylphosphine)palladium(0) was added and refluxing was conducted for 2 hours. After completion of the reaction, the organic phase was extracted with chloroform, washed with water, and dried over anhydrous sodium sulfate. The solvent was removed under vacuum and the residue was purified by silica gel chromatography. As a result, 3.2 parts of compound A216 was obtained.

### Synthetic Example 5

By the same method as that in Synthetic Example 4, 7.4 parts of 2,7-dibromo-9,10-phenanthrolinequinone was synthesized in a nitrogen atmosphere from 2.8 parts of 3-aminophenylboronic acid monohydrate and phenanthrolinequinone (produced by Sigma-Aldrich Japan). To a mixed solvent containing 100 parts of toluene and 50 parts of ethanol, 7.4 parts of 2,7-dibromo-9,10-phenanthrolinequinone was added and 100 parts of a 20% aqueous sodium carbonate solution was added dropwise to the resulting mixture. Then 0.55 parts of tetrakis(triphenylphosphine)palladium(0) was added and refluxing was conducted for 2 hours. After completion of the reaction, the organic phase was extracted with chloroform, washed with water, and dried over anhydrous sodium sulfate. The solvent was removed under vacuum and the residue was purified by silica gel chromatography. As a result, 2.2 parts of compound A316 was obtained.

### Synthetic Example 6

To 200 parts of dimethylacetamide, 7.4 parts of perylenetetracarboxylic dianhydride (produced by Tokyo Chemical Industry Co., Ltd.), 4 parts of 2,6-diethylaniline (produced by Tokyo Chemical Industry Co., Ltd.), and 4 parts of 2-aminophenylethanol were added in a nitrogen atmosphere. Stirring was conducted at room temperature for 1 hour to prepare a solution. The solution prepared was refluxed for 8 hours. Precipitates were filtered out and recrystallized with ethyl acetate. As a result, 5.0 parts of compound A803 was obtained.

### Synthetic Example 7

To 200 parts of dimethylacetamide, 5.4 parts of a naphthalenetetracarboxylic dianhydride and 5.2 parts of leucinol were added in a nitrogen atmosphere. The resulting mixture was stirred at room temperature for 1 hour and refluxed for 7 hours. Dimethylacetamide was removed by vacuum distillation and the product was recrystallized with ethyl acetate. As a result, 5.0 parts of compound A157 was obtained.

### Synthetic Example 8

To 200 parts of dimethylacetamide, 5.4 parts of a naphthalenetetracarboxylic dianhydride, 2.6 parts of leucinol, and 2.7 parts of 2-(2-aminoethylthio)ethanol were added in a nitrogen atmosphere. The resulting mixture was stirred at room temperature for 1 hour and refluxed for 7 hours. Dimethylacetamide was removed by vacuum distillation from a dark brown solution obtained and the product was dissolved in an ethyl acetate/toluene mixed solution.

The resulting mixture was fractionized through silica gel chromatography (eluent: ethyl acetate/toluene) and then the fraction containing the target substance was condensed. The resulting crystals were recrystallized in a toluene/hexane mixed solution. As a result, 2.5 parts of compound A177 was obtained.

Preparation and evaluation of electrophotographic photosensitive members will now be described.

### Example 1

An aluminum cylinder (Japanese Industrial Standard (JIS) A3003, aluminum alloy) having a length of 260.5 mm and a diameter of 30 mm was used as a support (conductive support).

Into a sand mill containing glass beads 1 mm in diameter, 50 parts of titanium oxide particles (powder resistivity: 120 Ω·cm, coverage of tin oxide: 40%) coated with oxygen deficient tin oxide, 40 parts of a phenolic resin (PLYOPHEN J-325 produced by DIC Corporation, resin solid content: 60%), and 50 parts of methoxypropanol were placed and a dispersion treatment was carried out for 3 hours to prepare a coating solution (dispersion) for forming a conductive layer. The coating solution was applied to the support by dip coating and the resulting coating film was dried and thermally cured at 150° C. for 30 minutes. As a result, a conductive layer having a thickness of 28 μm was obtained.

The average particle size of the titanium oxide particles coated with oxygen-deficient tin oxide in the coating solution for the conductive layer was measured with a particle size analyzer (trade name: CAPA 700 produced by Horiba Ltd.) by using tetrahydrofuran as the dispersion medium through a centrifugal sedimentation technique at 5000 rpm. The average particle size observed was 0.31 μm.

In a mixed solvent containing 100 parts of dimethylacetamide and 100 parts of methyl ethyl ketone, 5 parts of a compound (A-101), 3.5 parts of an amine compound (C1-3), 3.4 parts of a resin (B1), and 0.1 parts of dodecylbenzenesulfonic acid serving as a catalyst were dissolved to prepare a coating solution for an undercoat layer.

The coating solution for an undercoat layer was applied to the conductive layer by dip coating and the resulting coating film was heated and cured (polymerized) at 160° C. for 40 minutes. As a result, an undercoat layer having a thickness of 0.5 μm was obtained.

Into a sand mill containing glass beads 1 mm in diameter, 250 parts of cyclohexanone, 5 parts of a polyvinyl butyral resin (trade name: S-LEC BX-1 produced by Sekisui Chemical Co., Ltd.), and 10 parts of hydroxygallium phthalocyanine crystals (charge generating substance) that have intense peaks at Bragg's angles (2θ±0.2° of 7.5°, 9.9°, 12.5°, 16.3°, 18.6°, 25.1°, and 28.3° in X-ray diffraction with CuKα radiation were placed and a dispersion treatment was carried out for 1.5 hours. To the resulting mixture, 250 parts of ethyl acetate was added to prepare a coating solution for a charge generating layer. The coating solution for the charge generating layer was applied to the undercoat layer by dip coating and the resulting coating film was dried at 100° C. for 10 minutes to form a charge generating layer having a thickness of 0.15 μm.

In a mixed solvent containing 40 parts of dimethoxymethane and 60 parts of o-xylene, 8 parts of an amine compound (hole transporting substance) represented by formula (15) below and 10 parts of a polyester resin (H) being constituted by a repeating structural unit represented by formula (16-1) below and a repeating structural unit represented by formula (16-2) below at a 5/5 ratio and having a weight-average molecular weight (Mw) of 100,000 were dissolved to prepare a coating solution for a charge transporting layer. The coating solution for the charge transporting layer was applied to the charge generating layer by dip coating and the resulting coating film was dried at 120° C. for 40 minutes. As a result, a charge (hole) transporting layer having a thickness of 15 μm was obtained.

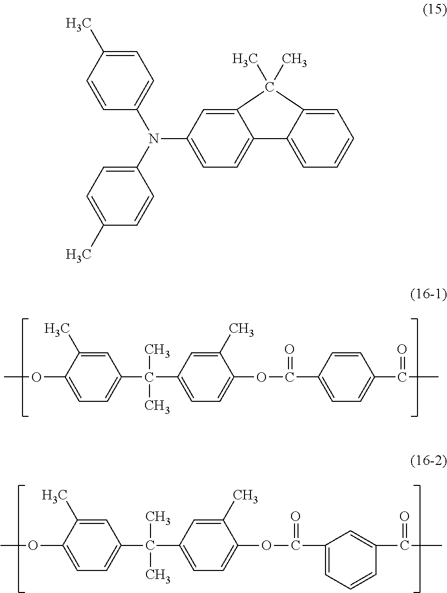

As a result, an electrophotographic photosensitive member that included a conductive layer, an undercoat layer, a charge generating layer, and a charge transporting layer that were stacked in that order on a support was obtained.

### Evaluation

The electrophotographic photosensitive member obtained was loaded in a modified laser beam printer (trade name: LBP-2510 produced by Canon Kabushiki Kaisha) in a 23° C. 50% RH environment (preexposure: OFF, primary charging: roller-contact DC charging, process peed: 120 mm/sec, laser exposure). The surface potential was measured and the output images were evaluated. The details are described below.

### Measurement of Surface Potential

The surface potential was measured as follows. A cyan process cartridge of the laser beam printer described above was modified by attaching a potential probe (model 6000B-8 produced by TREK JAPAN KK) at a development position. The potential at the central part of the electrophotographic photosensitive member was measured with a surface potentiometer (model 1344 produced by TREK JAPAN KK). The dose of the image exposure was set so that the surface potential of the drum was −600 V in terms of a dark potential (Vd) and −200 V in terms of a light potential (Vl).

### Evaluation of Positive Ghosting

The electrophotographic photosensitive member prepared was loaded in the cyan process cartridge of the laser beam printer described above. The process cartridge was attached to the cyan process cartridge station and images were output. First, one sheet with a solid white image, five sheets with images for ghosting evaluation, one sheet with a solid black image, and five sheets with images for ghosting evaluation were continuously output in that order. Then full color images (characters with a printing ratio of 1% for each color) were output on 3,000 sheets of A4 size regular paper and then one sheet with a solid white image, five sheets with images for ghosting evaluation, one sheet with a solid black image, and five sheets with images for ghosting evaluation were continuously output in that order.

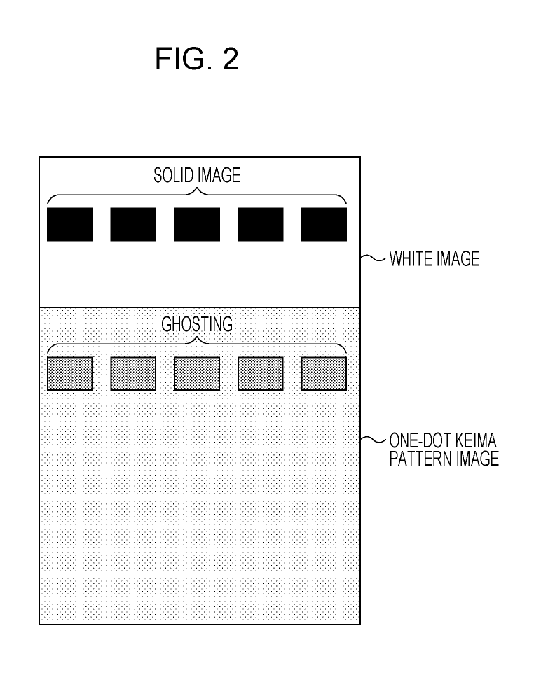

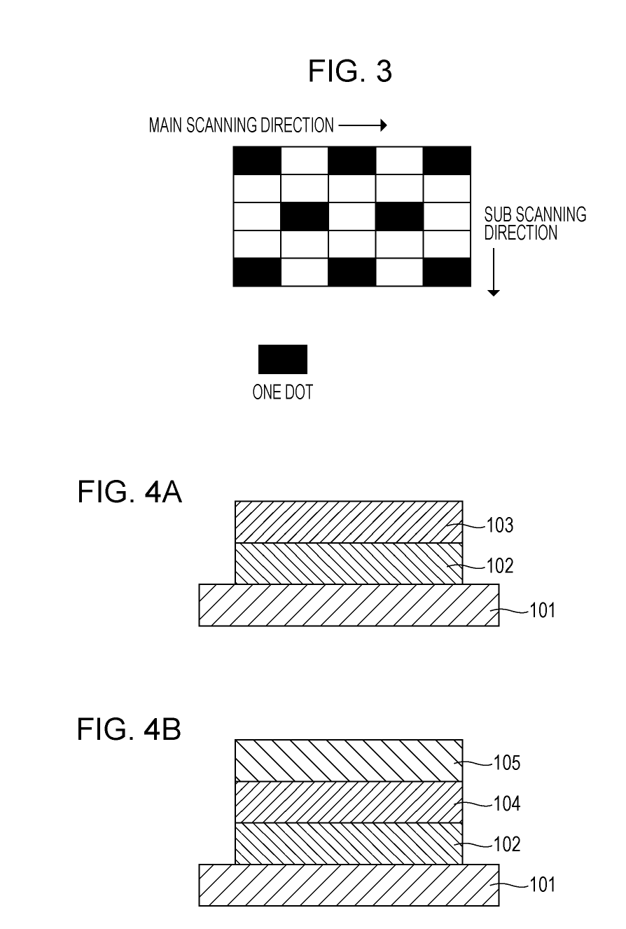

FIG. 2 shows the image for evaluating ghosting. As shown in FIG. 2, the printout includes a white image portion in an upper portion where square solid images were printed and a Keima-pattern portion in a lower portion where a half tone image of a variation of a Keima-pattern as shown in FIG. 3 was printed. In FIG. 2, portions where ghosting derived from solid images can occur are marked as “ghosting”.

The positive ghosting evaluation was carried out by measuring the difference between the image density of the half tone image of the Keima-pattern and the image density at the ghosting portions. The density difference was measured at ten points in one sheet of the image for ghosting evaluation by using a spectro densitomer (trade name: X-Rite 504/508, produced by X-Rite Inc.). This operation was conducted on all of the ten sheets of the images for ghosting evaluation and the results of that total of one hundred points were averaged to find the Macbeth density difference (initial) at the time of initial image output. Next, after outputting 3,000 sheets of paper, the difference (change) between the Macbeth density difference after the output and the Macbeth density difference at the time of initial image output was determined and assumed to be the amount of change in Macbeth density difference. The smaller the change in Macbeth density difference, the more suppressed the positive ghosting. The smaller the difference between the Macbeth density difference after output of 3,000 sheets and the Macbeth density difference at the time of initial image output, the smaller the change induced by positive ghosting. The results are shown in Table 11.

### Examples 2 to 150

An electrophotographic photosensitive member was produced as in Example 1 except that the types and contents of the electron transporting substance (compound A), the resin (resin B) having a repeating structural unit represented by formula (B), and the amine compound (compound C) used in Example 1 were changed as shown in Tables 11 to 13. Evaluation of the positive ghosting was conducted in the same manner. The results are shown in Tables 11 to 13.

### Example 151

An electrophotographic photosensitive member was produced as in Example 1 except that preparation of the coating solution for a conductive layer, the coating solution for an undercoating layer, and the coating solution for a charge transporting layer were altered as follows. Evaluation of the positive ghosting was conducted in the same manner. The results are shown in Table 14.

Preparation of the coating solution for a conductive layer was altered as follows. Into a sand mill containing 450 parts of glass beads 0.8 mm in diameter, 214 parts of titanium oxide (TiO₂) coated with oxygen deficient tin oxide (SnO₂) (serving as metal oxide particles), 132 parts of a phenolic resin (trade name: PLYOPHEN J-325) as the binder resin, and 98 parts of 1-methoxy-2-propanol as the solvent were placed and a dispersion treatment was carried out at a speed of rotation of 2000 rpm, a dispersion treatment time of 4.5 hours, and a cooling water setting temperature of 18° C. to obtain a dispersion. The dispersion was passed through a mesh (150 μm aperture) to remove the glass beads.

Silicone resin particles (trade name: Tospearl 120 produced by Momentive Performance Materials Inc., average particle diameter: 2 μm) serving as a surface roughness imparter were added to the dispersion after the removal of the glass beads so that the amount of the silicone resin particles was 10 mass % relative to the total mass of the binder resin and the metal oxide particles in the dispersion. A silicone oil (trade name: SH28PA produced by Dow Corning Toray Co., Ltd.) serving as a leveling agent was added to the dispersion so that the amount of the silicone oil was 0.01 mass % relative to the total mass of the metal oxide particles and the binder resin in the dispersion. The resulting mixture was stirred to prepare a coating solution for a conductive layer. The coating solution for a conductive layer was applied to a support by dip coating and the resulting coating film was dried and thermally cured at 150° C. for 30 minutes. As a result, a conductive layer having a thickness of 30 μm was obtained.

Preparation of the coating solution for an undercoat layer was altered as follows. In a mixed solvent containing 100 parts of dimethylacetamide and 100 parts of methyl ethyl ketone, 5 parts of a compound (A157), 3.5 parts of a melamine compound (C1-3), 3.4 parts of a resin (B25), and 0.1 parts of dodecylbenzenesulfonic acid serving as a catalyst were dissolved to prepare a coating solution for an undercoat layer. The coating solution for an undercoat layer was applied to the conductive layer by dip coating and the resulting coating film was heated and cured (polymerized) at 160° C. for 40 minutes. As a result, an undercoat layer having a thickness of 0.5 μm was obtained.

Preparation of the coating solution for a charge transporting layer was altered as follows. In a mixed solvent containing 30 parts of dimethoxymethane and 50 parts of ortho-xylene, 9 parts of a charge transporting substance having a structure represented by formula (15), 1 part of a charge transporting substance having a structure represented by formula (18) below, 3 parts of a polyester resin F (weight-average molecular weight: 90,000) having a repeating structural unit represented by formula (24) below, a repeating structural unit represented by formula (25) below, and a repeating structural unit represented by formula (26) below (the (26):(25) ratio being 7:3), and 7 parts of a polyester resin H (weight-average molecular weight: 120,000) having a repeating structure represented by formula (16-1) and a repeating structure represented by formula (16-2) at a 5:5 ratio were dissolved to prepare a coating solution for a charge transporting layer. In the polyester resin F, the content of the repeating structural unit represented by formula (24) below was 10 mass % and the total content of the repeating structural units represented by formulae (25) and (26) below was 90 mass %.

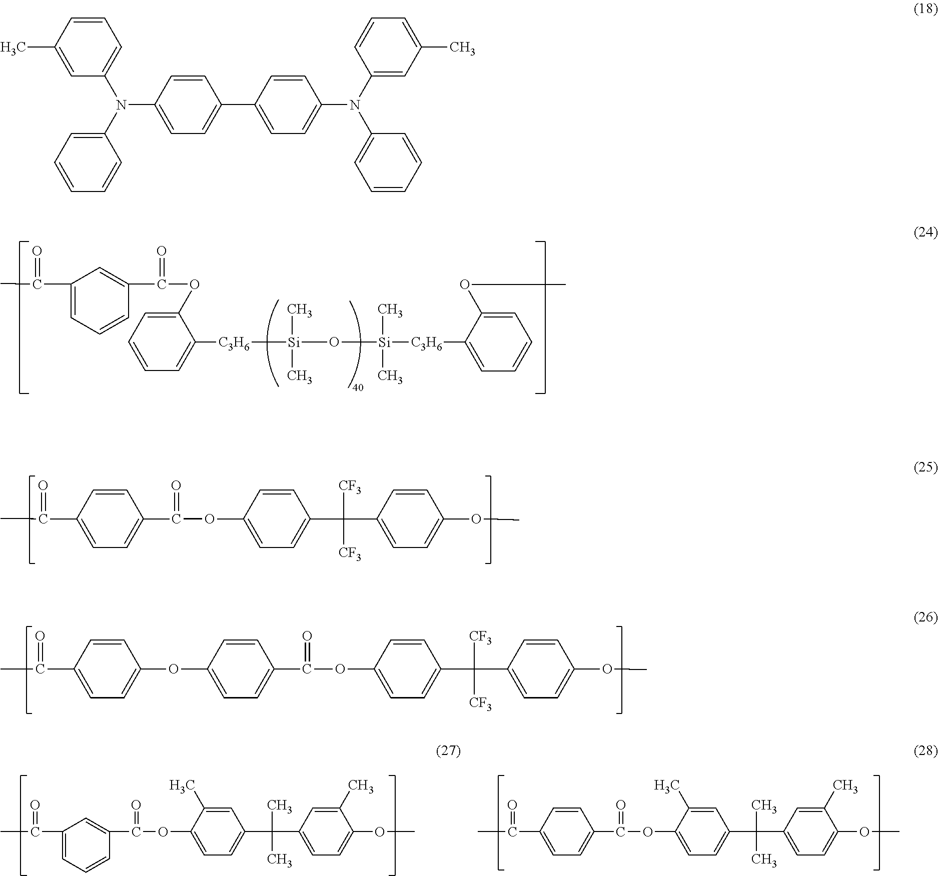

The coating solution for a charge transporting layer was applied to the charge generating layer by dip coating and dried at 120° C. for 1 hour. As a result, a charge transporting layer having a thickness of 16 μm was formed. The charge transporting layer formed was confirmed to contain a domain structure containing the polyester resin F in the matrix containing the charge transporting substance and the polyester resin H.

### Example 152

An electrophotographic photosensitive member was produced as in Example 151 except that preparation of the coating solution for a charge transporting layer was altered as follows. Evaluation of the positive ghosting was conducted in the same manner. The results are shown in Table 14.

Preparation of the coating solution for a charge transporting layer was altered as follows. In a mixed solvent containing 30 parts of dimethoxymethane and 50 parts of ortho-xylene, 9 parts of a charge transporting substance having a structure represented by formula (15), 1 part of a charge transporting substance having a structure represented by formula (18), 10 parts of a polycarbonate resin I (weight-average molecular weight: 70,000) having a repeating structural unit represented by formula (29), and 0.3 parts of a polycarbonate resin J (weight-average molecular weight: 40,000) having a repeating structural unit represented by formula (29) and a repeating structural unit represented by formula (30), and a structure represented by formula (31) in at least one terminus were dissolved to prepare a coating solution for a charge transporting layer. The total mass of the repeating structural unit represented by formula (30) and the structure represented by formula (31) in the polycarbonate resin J was 30 mass %. The coating solution for a charge transporting layer was applied to the charge generating layer by dip coating and dried at 120° C. for 1 hour. As a result, a charge transporting layer having a thickness of 16 μm was obtained.

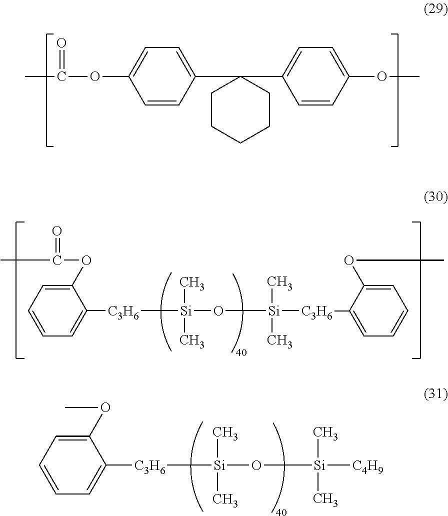

### Example 153

An electrophotographic photosensitive member was produced as in Example 152 except that, in preparing the coating solution for a charge transporting layer in Example 152, 10 parts of the polyester resin H (weight-average molecular weight: 120,000) was used instead of 10 parts of the polycarbonate resin I (weight-average molecular weight: 70,000). Evaluation of the positive ghosting was conducted in the same manner. The results are shown in Table 14.

### Examples 154 to 156

Electrophotographic photosensitive members were produced as in Examples 151 to 153 except that preparation of the coating solution for a conductive layer in Examples 151 to 153 was altered as follows. Evaluation of positive ghosting was conducted in the same manner. The results are shown in Table 14.

The preparation of the coating solution for a conductive layer was altered as follows. Into a sand mill containing 450 parts of glass beads 0.8 mm in diameter, 207 parts of titanium oxide (TiO₂) coated with a phosphorus (P)-doped tin oxide (SnO₂) (serving as metal oxide particles), 144 parts of a phenolic resin (trade name: PLYOPHEN J-325) as the binder resin, and 98 parts of 1-methoxy-2-propanol as the solvent were placed and a dispersion treatment was carried out at a speed of rotation of 2000 rpm, a dispersion treatment time of 4.5 hours, and a cooling water setting temperature of 18° C. to obtain a dispersion. The dispersion was passed through a mesh (150 μm aperture) to remove the glass beads.

Silicone resin particles (trade name: Tospearl 120) serving as a surface roughness imparter were added to the dispersion after the removal of the glass beads so that the amount of the silicone resin particles was 15 mass % relative to the total mass of the binder resin and the metal oxide particles in the dispersion. A silicone oil (trade name: SH28PA) serving as a leveling agent was added to the dispersion so that the amount of the silicone oil was 0.01 mass % relative to the total mass of the metal oxide particles and the binder resin in the dispersion. The resulting mixture was stirred to prepare a coating solution for a conductive layer. The coating solution for a conductive layer was applied to a support by dip coating and the resulting coating film was dried and thermally cured at 150° C. for 30 minutes. As a result, a conductive layer having a thickness of 30 μm was obtained.

### Examples 157 and 158

Electrophotographic photosensitive members were produced as in Example 151 except that the type and content of the electron transporting substance were changed as in Table 14. Evaluation of positive ghosting was performed in the same manner. The results are shown in Table 14.

TABLE 11

| | Compound A | | | Compound C | | | Resin B | | | |
|---|---|---|---|---|---|---|---|---|---|---|
| | | Parts by | Molecular | | Parts by | Molecular | | Parts by | Macbeth density | Macbeth density |
| Example | Type | mass | weight | Type | mass | weight | Type | mass | (change) | (initial) |
| 1 | A101 | 5 | 456.5 | C1-3 | 3.5 | 558 | B1 | 3.4 | 0.002 | 0.025 |
| 2 | A101 | 6 | 456.5 | C1-3 | 3.5 | 558 | B1 | 3.4 | 0.002 | 0.024 |
| 3 | A101 | 7 | 456.5 | C1-3 | 3.5 | 558 | B1 | 3.4 | 0.002 | 0.023 |
| 4 | A101 | 4 | 456.5 | C1-3 | 3.5 | 558 | B1 | 3.4 | 0.002 | 0.026 |
| 5 | A101 | 8 | 456.5 | C1-3 | 3.5 | 558 | B1 | 3 | 0.002 | 0.022 |
| 6 | A101 | 5 | 456.5 | C1-2 | 2.5 | 390 | B1 | 3.4 | 0.002 | 0.025 |
| 7 | A101 | 5 | 456.5 | C1-11 | 3.3 | 520 | B1 | 3.4 | 0.002 | 0.025 |
| 8 | A101 | 5 | 456.5 | C1-10 | 3.5 | 548 | B2 | 3.4 | 0.002 | 0.025 |
| 9 | A101 | 5 | 456.5 | C1-12 | 3.5 | 521 | B3 | 3.4 | 0.002 | 0.025 |
| 10 | A101 | 5 | 456.5 | C1-6 | 3.2 | 506 | B19 | 3.4 | 0.002 | 0.027 |
| 11 | A101 | 5 | 456.5 | C1-5 | 2.5 | 392 | B20 | 3.4 | 0.002 | 0.025 |
| 12 | A101 | 5 | 456.5 | C1-2 | 2.5 | 390 | B20 | 3.4 | 0.002 | 0.025 |
| 13 | A101 | 5 | 456.5 | C1-7 | 3.5 | 558 | B21 | 3 | 0.002 | 0.025 |
| 14 | A101 | 5 | 456.5 | C1-8 | 3.5 | 558 | B21 | 3 | 0.002 | 0.027 |
| 15 | A101 | 5 | 456.5 | C1-5 | 2.5 | 392 | B1 | 3.4 | 0.002 | 0.025 |
| 16 | A101 | 5 | 456.5 | C1-6 | 3.2 | 506 | B1 | 3.4 | 0.003 | 0.025 |
| 17 | A101 | 5 | 456.5 | C1-6 | 3.2 | 506 | B1 | 3.4 | 0.003 | 0.026 |
| 18 | A103 | 5 | 490.5 | C1-3 | 3.5 | 558 | B1 | 3.7 | 0.002 | 0.025 |
| 19 | A112 | 5 | 518.5 | C1-3 | 3.5 | 558 | B8 | 1.6 | 0.002 | 0.027 |
| 20 | A113 | 5 | 489.5 | C1-3 | 3.5 | 558 | B9 | 4 | 0.003 | 0.027 |
| 21 | A114 | 5 | 506.6 | C1-3 | 3.5 | 558 | B10 | 4 | 0.002 | 0.027 |
| 22 | A119 | 5 | 506.5 | C1-3 | 3.5 | 558 | B2 | 4 | 0.002 | 0.025 |
| 23 | A123 | 5 | 500.4 | C1-3 | 3.5 | 558 | B2 | 4.5 | 0.002 | 0.025 |
| 24 | A124 | 5 | 410.4 | C2-12 | 2.7 | 495.7 | B1 | 4 | 0.002 | 0.025 |
| 25 | A128 | 5 | 534.5 | C1-3 | 8.4 | 558 | B10 | 3 | 0.002 | 0.024 |
| 26 | A131 | 5 | 527.6 | C1-3 | 3.5 | 558 | B2 | 1.7 | 0.002 | 0.024 |
| 27 | A134 | 5 | 506.5 | C1-3 | 3.5 | 558 | B2 | 3.5 | 0.002 | 0.025 |
| 28 | A135 | 5 | 534.6 | C1-3 | 3.5 | 558 | B2 | 0.4 | 0.002 | 0.024 |
| 29 | A101 | 5 | 456.5 | C2-3 | 2.4 | 419.5 | B2 | 1.4 | 0.002 | 0.025 |
| 30 | A125 | 5 | 478.5 | C2-4 | 2.9 | 505.7 | B12 | 1.4 | 0.002 | 0.025 |
| 31 | A136 | 5 | 534.6 | C1-10 | 3.5 | 548 | B12 | 1.2 | 0.002 | 0.026 |
| 32 | A142 | 5 | 582.6 | C1-7 | 3.5 | 558 | B12 | 3.5 | 0.002 | 0.026 |
| 33 | A152 | 5 | 424.5 | C1-6 | 3.4 | 506 | B12 | 3.1 | 0.002 | 0.025 |
| 34 | A514 | 5 | 434.4 | C4-4 | 3.2 | 430.5 | B1 | 2.5 | 0.002 | 0.027 |
| 35 | A514 | 5 | 434.4 | C3-4 | 3.2 | 419.6 | B2 | 2.2 | 0.002 | 0.027 |
| 36 | A514 | 5 | 434.4 | C2-11 | 3.3 | 413.6 | B1 | 2.5 | 0.002 | 0.028 |
| 37 | A514 | 5 | 434.4 | C2-17 | 3.3 | 407.5 | B3 | 2.5 | 0.003 | 0.027 |
| 38 | A514 | 5 | 434.4 | C1-5 | 3.5 | 392 | B20 | 1.3 | 0.002 | 0.028 |
| 39 | A531 | 5 | 334.4 | C1-9 | 3.5 | 378 | B1 | 1.3 | 0.002 | 0.028 |
| 40 | A531 | 5 | 334.4 | C2-1 | 2.1 | 353.4 | B1 | 1 | 0.002 | 0.028 |
| 41 | A531 | 5 | 334.4 | C3-3 | 3.4 | 363.5 | B20 | 1 | 0.003 | 0.028 |
| 42 | A531 | 5 | 334.4 | C4-2 | 2.4 | 318.3 | B20 | 1.3 | 0.002 | 0.027 |
| 43 | A522 | 5 | 410.5 | C3-4 | 3.1 | 419.6 | B9 | 1.3 | 0.002 | 0.027 |
| 44 | A531 | 5 | 334.4 | C5-4 | 3.8 | 348.5 | B20 | 1 | 0.003 | 0.027 |
| 45 | A532 | 5 | 451.4 | C2-16 | 2.2 | 489.7 | B20 | 2 | 0.003 | 0.027 |
| 46 | A521 | 5 | 272.3 | C4-1 | 2 | 262.2 | B17 | 2 | 0.003 | 0.027 |
| 47 | A521 | 5 | 272.3 | C5-3 | 3.2 | 292.4 | B17 | 1.5 | 0.003 | 0.027 |
| 48 | A521 | 5 | 272.3 | C1-1 | 2.1 | 306 | B8 | 1.3 | 0.003 | 0.027 |
| 49 | A521 | 5 | 272.3 | C1-4 | 2.1 | 302 | B16 | 1 | 0.003 | 0.027 |
| 50 | A521 | 5 | 272.3 | C2-13 | 2.1 | 329 | B16 | 1.3 | 0.003 | 0.027 |

TABLE 12

| | Compound A | | | Compound C | | | Resin B | | | |
|---|---|---|---|---|---|---|---|---|---|---|
| | | Parts by | Molecular | | Parts by | Molecular | | Parts by | Macbeth density | Macbeth density |
| Example | Type | mass | weight | Type | mass | weight | Type | mass | (change) | (initial) |
| 51 | A601 | 5 | 264 | C4-6 | 2.8 | 290.3 | B1 | 1.4 | 0.002 | 0.035 |
| 52 | A601 | 5 | 264 | C1-4 | 2 | 302 | B1 | 1.4 | 0.002 | 0.032 |
| 53 | A601 | 5 | 264 | C5-2 | 3.2 | 236.3 | B20 | 1.5 | 0.002 | 0.036 |
| 54 | A603 | 5 | 278 | C3-2 | 2.5 | 262.3 | B8 | 2 | 0.002 | 0.035 |
| 55 | A603 | 5 | 278 | C2-13 | 2.1 | 329 | B8 | 0.8 | 0.002 | 0.035 |
| 56 | A603 | 5 | 278 | C1-4 | 2.1 | 302 | B8 | 1.4 | 0.002 | 0.037 |
| 57 | A602 | 5 | 264.3 | C1-1 | 2.1 | 306 | B1 | 1.5 | 0.002 | 0.033 |
| 58 | A602 | 5 | 264.3 | C3-6 | 2.4 | 234.3 | B12 | 1.2 | 0.003 | 0.034 |
| 59 | A602 | 5 | 264.3 | C4-5 | 2.3 | 274.3 | B12 | 1.2 | 0.003 | 0.035 |
| 60 | A610 | 5 | 198.2 | C5-1 | 2.2 | 180.2 | B9 | 1.1 | 0.002 | 0.035 |
| 61 | A725 | 5 | 508.7 | C1-7 | 3.6 | 558 | B1 | 3 | 0.002 | 0.035 |
| 62 | A726 | 5 | 548.6 | C1-3 | 3.6 | 558 | B1 | 3 | 0.002 | 0.037 |
| 63 | A727 | 5 | 536.6 | C2-4 | 2.9 | 505.7 | B17 | 2.1 | 0.002 | 0.033 |
| 64 | A728 | 5 | 478.6 | C4-4 | 3.2 | 430.5 | B9 | 2.5 | 0.003 | 0.034 |
| 65 | A729 | 5 | 512.7 | C1-6 | 3.3 | 506 | B10 | 3.5 | 0.003 | 0.035 |
| 66 | A725 | 5 | 548.6 | C1-11 | 3.3 | 520 | B3 | 3.4 | 0.002 | 0.035 |
| 67 | A726 | 5 | 548.6 | C1-12 | 3.3 | 521 | B1 | 3.5 | 0.002 | 0.036 |
| 68 | A701 | 5 | 290.3 | C4-2 | 2.4 | 318.3 | B1 | 1.8 | 0.002 | 0.035 |
| 69 | A803 | 5 | 642.7 | C1-3 | 3.5 | 558 | B5 | 3 | 0.002 | 0.032 |
| 70 | A803 | 5 | 642.7 | C1-10 | 3.5 | 548 | B6 | 3.3 | 0.002 | 0.037 |
| 71 | A805 | 5 | 628.7 | C1-3 | 3.5 | 558 | B14 | 3 | 0.002 | 0.037 |
| 72 | A812 | 5 | 642.7 | C1-7 | 3.5 | 558 | B16 | 4 | 0.003 | 0.035 |
| 73 | A813 | 5 | 613.7 | C1-12 | 3.4 | 521 | B9 | 4.5 | 0.003 | 0.035 |
| 74 | A814 | 5 | 630.7 | C1-10 | 3.3 | 548 | B10 | 4.5 | 0.002 | 0.036 |
| 75 | A819 | 5 | 630.7 | C1-8 | 3.5 | 558 | B21 | 4.5 | 0.002 | 0.035 |
| 76 | A216 | 5 | 420 | C3-4 | 3.9 | 419.6 | B1 | 1 | 0.002 | 0.045 |
| 77 | A217 | 5 | 448 | C2-15 | 2.8 | 467.7 | B17 | 1.1 | 0.002 | 0.045 |
| 78 | A219 | 5 | 424.5 | C2-17 | 2.3 | 407.5 | B10 | 1.1 | 0.002 | 0.042 |
| 79 | A225 | 5 | 472.6 | C2-16 | 2.7 | 489.7 | B1 | 0.4 | 0.002 | 0.048 |
| 80 | A226 | 5 | 438.5 | C4-4 | 3.2 | 430.5 | B17 | 0.5 | 0.002 | 0.042 |
| 81 | A227 | 5 | 496.5 | C1-6 | 3.3 | 506 | B9 | 2.2 | 0.003 | 0.044 |
| 82 | A228 | 5 | 468.5 | C2-3 | 2.5 | 419.5 | B10 | 0.4 | 0.003 | 0.045 |
| 83 | A314 | 5 | 422 | C1-2 | 3.5 | 390 | B1 | 1.1 | 0.002 | 0.043 |
| 84 | A315 | 5 | 450 | C1-6 | 3.5 | 506 | B17 | 0.5 | 0.002 | 0.046 |
| 85 | A316 | 5 | 392 | C1-5 | 2.5 | 392 | B9 | 1.5 | 0.002 | 0.048 |
| 86 | A317 | 5 | 426.5 | C3-4 | 4 | 419.6 | B10 | 1.5 | 0.002 | 0.043 |
| 87 | A412 | 5 | 453.5 | C4-4 | 3.2 | 430.5 | B1 | 1.7 | 0.002 | 0.043 |
| 88 | A412 | 5 | 453.5 | C1-5 | 3.5 | 392 | B14 | 1.6 | 0.002 | 0.046 |
| 89 | A415 | 5 | 442 | C2-6 | 2.8 | 405.5 | B23 | 0.2 | 0.002 | 0.042 |
| 90 | A416 | 5 | 470.4 | C2-15 | 2.4 | 467.7 | B17 | 0.4 | 0.002 | 0.045 |
| 91 | A418 | 5 | 446.5 | C1-12 | 3.4 | 521 | B10 | 0.3 | 0.003 | 0.046 |
| 92 | A431 | 5 | 536.6 | C1-10 | 3.4 | 548 | B1 | 2.6 | 0.002 | 0.042 |
| 93 | A902 | 5 | 238.2 | C5-6 | 2.3 | 208.2 | B1 | 2 | 0.003 | 0.045 |
| 94 | A924 | 5 | 476.5 | C1-6 | 3.5 | 506 | B18 | 1.8 | 0.003 | 0.045 |
| 95 | A919 | 5 | 364.4 | C4-2 | 2.6 | 318.3 | B22 | 1.5 | 0.003 | 0.046 |
| 96 | A418 | 5 | 446.5 | C1-12 | 3.4 | 521 | B10 | 0.3 | 0.003 | 0.046 |
| 97 | A431 | 5 | 536.6 | C1-10 | 3.4 | 548 | B1 | 2.6 | 0.002 | 0.042 |
| 98 | A902 | 5 | 238.2 | C5-6 | 2.3 | 208.2 | B2 | 2 | 0.003 | 0.045 |
| 99 | A924 | 5 | 476.5 | C1-6 | 3.5 | 506 | B2 | 1.8 | 0.003 | 0.045 |
| 100 | A919 | 5 | 364.4 | C4-2 | 2.6 | 318.3 | B2 | 1.5 | 0.003 | 0.046 |

TABLE 13

| | Compound A | | | Compound C | | | Resin B | | | |
|---|---|---|---|---|---|---|---|---|---|---|
| | | Parts by | Molecular | | Parts by | Molecular | | Parts by | Macbeth density | Macbeth density |
| Example | Type | mass | weight | Type | mass | weight | Type | mass | (change) | (initial) |
| 101 | A101 | 5 | 456.5 | C4-3 | 2.8 | 374.4 | B1 | 3.2 | 0.004 | 0.026 |
| 102 | A110 | 5 | 422.5 | C1-8 | 3.5 | 558 | B20 | 3.1 | 0.004 | 0.024 |
| 103 | A101 | 5 | 456.5 | C3-3 | 3.8 | 363.5 | B3 | 3.2 | 0.004 | 0.025 |
| 104 | A101 | 5 | 456.5 | C2-13 | 2.8 | 329 | B3 | 3 | 0.004 | 0.024 |
| 105 | A113 | 5 | 489.5 | C1-9 | 2.4 | 378 | B9 | 3.3 | 0.004 | 0.026 |
| 106 | A107 | 5 | 504.4 | C1-2 | 2.6 | 390 | B2 | 3.4 | 0.004 | 0.027 |
| 107 | A107 | 5 | 504.4 | C5-4 | 4 | 348.5 | B2 | 3.5 | 0.004 | 0.026 |
| 108 | A124 | 5 | 410.4 | C1-7 | 3.5 | 558 | B14 | 3.5 | 0.004 | 0.027 |
| 109 | A124 | 5 | 410.4 | C1-10 | 3.5 | 548 | B23 | 3.5 | 0.004 | 0.025 |
| 110 | A514 | 5 | 434.4 | C1-8 | 3.5 | 558 | B20 | 3.5 | 0.004 | 0.025 |
| 111 | A522 | 5 | 410.5 | C5-3 | 3.3 | 292.4 | B9 | 1.5 | 0.004 | 0.027 |
| 112 | A532 | 5 | 451.4 | C3-3 | 3.6 | 363.5 | B13 | 1.5 | 0.004 | 0.027 |
| 113 | A531 | 5 | 334.4 | C2-15 | 3.6 | 467.7 | B14 | 1.5 | 0.004 | 0.027 |
| 114 | A532 | 5 | 451.4 | C2-7 | 3.3 | 343.4 | B23 | 1.1 | 0.004 | 0.027 |
| 115 | A521 | 5 | 272.3 | C1-5 | 3.9 | 392 | B8 | 1.4 | 0.004 | 0.027 |
| 116 | A616 | 5 | 342.3 | C5-2 | 2.7 | 236.3 | B1 | 0.8 | 0.004 | 0.037 |
| 117 | A602 | 5 | 264.3 | C2-17 | 3.6 | 407.5 | B19 | 0.8 | 0.004 | 0.035 |
| 118 | A610 | 5 | 198.2 | C3-3 | 3.6 | 262.3 | B9 | 1.3 | 0.005 | 0.034 |
| 119 | A701 | 5 | 290.3 | C2-8 | 3.5 | 399.5 | B1 | 0.9 | 0.004 | 0.035 |
| 120 | A725 | 5 | 478.6 | C2-1 | 2.2 | 353.4 | B1 | 0.6 | 0.004 | 0.036 |
| 121 | A726 | 5 | 548.6 | C2-2 | 2.3 | 393.5 | B11 | 1.5 | 0.004 | 0.036 |
| 122 | A812 | 5 | 642.7 | C1-6 | 3.4 | 506 | B8 | 3 | 0.004 | 0.035 |
| 123 | A814 | 5 | 630.7 | C4-4 | 3.3 | 430.5 | B10 | 3.3 | 0.004 | 0.036 |
| 124 | A819 | 5 | 630.7 | C2-9 | 2.9 | 481.7 | B3 | 2 | 0.004 | 0.035 |
| 125 | A414 | 5 | 301.3 | C2-4 | 3.7 | 505.7 | B1 | 2 | 0.004 | 0.046 |
| 126 | A430 | 5 | 350 | C5-2 | 2.7 | 236.3 | B2 | 1 | 0.004 | 0.044 |
| 127 | A232 | 5 | 417.4 | C1-10 | 3.5 | 548 | B3 | 3 | 0.004 | 0.045 |
| 128 | A316 | 5 | 392 | C1-12 | 3.3 | 521 | B9 | 3 | 0.004 | 0.045 |
| 129 | A902 | 5 | 238.2 | C5-1 | 2.3 | 180.2 | B12 | 2 | 0.004 | 0.045 |
| 130 | A101 | 5 | 456.5 | C5-3 | 3.3 | 292.4 | B1 | 2.6 | 0.008 | 0.026 |
| 131 | A101 | 5 | 456.5 | C3-2 | 2.6 | 262.3 | B1 | 3.1 | 0.009 | 0.028 |
| 132 | A521 | 5 | 272.3 | C1-7 | 5.6 | 558 | B17 | 1.4 | 0.008 | 0.027 |
| 133 | A725 | 5 | 478.6 | C5-3 | 3.3 | 292.4 | B1 | 3.5 | 0.009 | 0.037 |
| 134 | A812 | 5 | 642.7 | C2-2 | 2.4 | 393.5 | B8 | 1.5 | 0.009 | 0.036 |
| 135 | A601 | 5 | 264.3 | C1-7 | 3.8 | 558 | B23 | 1.5 | 0.008 | 0.038 |
| 136 | A412 | 5 | 453.5 | C5-3 | 3.3 | 292.4 | B14 | 3.6 | 0.009 | 0.048 |
| 137 | A414 | 5 | 301.3 | C5-1 | 2.1 | 180.2 | B12 | 2.5 | 0.009 | 0.045 |
| 138 | A232 | 5 | 417 | C3-2 | 2.6 | 262.3 | B12 | 3.2 | 0.011 | 0.043 |
| 139 | A316 | 5 | 392 | C3-6 | 2.4 | 234.3 | B9 | 3.8 | 0.011 | 0.045 |
| 140 | A317 | 5 | 426.5 | C4-5 | 2.2 | 274.3 | B10 | 3.3 | 0.011 | 0.046 |
| 141 | A924 | 5 | 476.5 | C1-4 | 3.3 | 302 | B8 | 3 | 0.011 | 0.044 |
| 142 | A902 | 5 | 238.2 | C1-3 | 4 | 558 | B1 | 2 | 0.013 | 0.035 |
| 143 | A412 | 5 | 453.5 | C3-2 | 2.7 | 262.3 | B11 | 3 | 0.015 | 0.045 |
| 144 | A232 | 5 | 417.4 | C4-1 | 2.6 | 262.2 | B11 | 3.1 | 0.016 | 0.045 |
| 145 | A412 | 5 | 453.5 | C3-2 | 2.6 | 262.3 | B11 | 1.1 | 0.023 | 0.045 |
| 146 | A222 | 5 | 252.2 | C1-7 | 5.6 | 558 | B18 | 0.5 | 0.024 | 0.045 |
| 147 | A421 | 5 | 274.3 | C5-1 | 3.5 | 180.2 | B18 | 2.2 | 0.021 | 0.045 |
| 148 | A924 | 5 | 476.5 | C1-4 | 5.9 | 302 | B18 | 2.1 | 0.025 | 0.045 |
| 149 | A314 | 5 | 422 | C5-2 | 3.5 | 236.3 | B24 | 3.5 | 0.022 | 0.045 |
| 150 | A902 | 5 | 238.2 | C1-7 | 3.4 | 558 | B24 | 3.1 | 0.021 | 0.045 |

TABLE 14

| | Compound A | | | Compound C | | | Resin B | | | |
|---|---|---|---|---|---|---|---|---|---|---|
| | | Parts by | Molecular | | Parts by | Molecular | Parts by | Molecular | Macbeth density | Macbeth density |
| Example | Type | mass | weight | Type | mass | weight | mass | weight | (change) | (initial) |
| 151 | A157 | 5 | 466.5 | C1-3 | 5 | 558 | B25 | 2.3 | 0.002 | 0.024 |
| 152 | A157 | 5 | 466.5 | C1-3 | 5 | 558 | B25 | 2.3 | 0.002 | 0.025 |
| 153 | A157 | 5 | 466.5 | C1-3 | 5 | 558 | B25 | 2.3 | 0.002 | 0.024 |
| 154 | A157 | 5 | 466.5 | C1-3 | 5 | 558 | B25 | 2.3 | 0.002 | 0.025 |
| 155 | A157 | 5 | 466.5 | C1-3 | 5 | 558 | B25 | 2.3 | 0.002 | 0.024 |
| 156 | A157 | 5 | 466.5 | C1-3 | 5 | 558 | B25 | 2.3 | 0.002 | 0.023 |
| 157 | A162 | 5 | 470.5 | C1-3 | 5 | 558 | B25 | 2.3 | 0.002 | 0.023 |
| 158 | A162 | 5 | 470.5 | C1-10 | 5 | 548 | B25 | 2.3 | 0.002 | 0.024 |

### Comparative Examples 1 to 8

Electrophotographic photosensitive members were produced as in Example 1 except that the resin B was not used and the types and contents of the charge transporting substance (compound A) and the amine compound (compound C) were changed as shown in Table 15. Evaluation of the positive ghosting was carried out in the same manner. The results are shown in Table 15.

### Comparative Examples 9 to 13

Electrophotographic photosensitive members were produced as in Example 1 except that the charge transporting substance was changed to a compound represented by formula (Y-1) below and the types and contents of the amine compound and the resin B were changed as shown in Table 15. Evaluation of the positive ghosting was carried out in the same manner. The results are shown in Table 15.

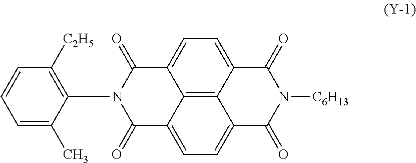

### Comparative Example 14

An electrophotographic photosensitive member was produced as in Example 1 except that the undercoat layer was prepared by using a block copolymer represented by the structural formula below (copolymer described in Japanese PCT Japanese Translation Patent Publication No. 2009-505156), a blocked isocyanate compound, and a vinyl chloride-vinyl acetate copolymer. Evaluation was conducted in the same manner. The initial Macbeth density was 0.03 and the change in Macbeth density was 0.05.

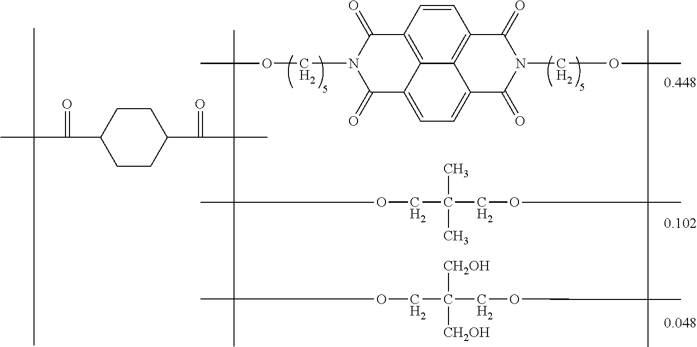

TABLE 15

| | Compound A, Comparative compound | | | Compound C | | | Resin B | | | |
|---|---|---|---|---|---|---|---|---|---|---|
| Comparative | | Parts by | Molecular | | Parts by | Molecular | | Parts by | Macbeth density | Macbeth density |
| Example | Type | mass | weight | Type | mass | weight | Type | mass | (change) | (initial) |
| 1 | A103 | 5 | 490.5 | C1-3 | 9.3 | 558 | — | — | 0.037 | 0.022 |
| 2 | A112 | 5 | 518.5 | C1-3 | 9.2 | 558 | — | — | 0.036 | 0.025 |
| 3 | A113 | 5 | 489.5 | C1-3 | 8.1 | 558 | — | — | 0.037 | 0.024 |
| 4 | A601 | 5 | 264 | C2-3 | 6.4 | 419.5 | — | — | 0.040 | 0.031 |
| 5 | A725 | 5 | 478.6 | C3-2 | 7.5 | 262.3 | — | — | 0.041 | 0.032 |
| 6 | A803 | 5 | 642.7 | C4-2 | 6.6 | 318.3 | — | — | 0.038 | 0.034 |
| 7 | A902 | 5 | 238.2 | C5-2 | 6.4 | 236.3 | — | — | 0.042 | 0.048 |
| 8 | A532 | 5 | 451.4 | C1-2 | 5.9 | 390 | — | — | 0.039 | 0.031 |
| 9 | Y-1 | 5 | 468.4 | C1-3 | 8.1 | 558 | — | — | 0.051 | 0.044 |
| 10 | Y-1 | 5 | 468.4 | C2-3 | 6.4 | 419.5 | — | — | 0.052 | 0.043 |
| 11 | Y-1 | 5 | 468.4 | C3-2 | 4.2 | 262.3 | B14 | 2.2 | 0.052 | 0.044 |
| 12 | Y-1 | 5 | 468.4 | C4-2 | 3.3 | 318.3 | B14 | 1.4 | 0.053 | 0.041 |
| 13 | Y-1 | 5 | 468.4 | C5-2 | 4.9 | 236.3 | B14 | 2.1 | 0.054 | 0.045 |

Examples and Comparative Examples 1 to 8 were compared. It was found that compared to electrophotographic photosensitive members that each contain a polymer obtained by polymerizing a composition containing an amine compound, a resin, and an electron transporting substance according to the present invention, the structures disclosed in Japanese Patent Laid-Open Nos. 2003-330209 and 2008-299344 do not always achieve a sufficient effect of reducing variation in positive ghosting in repeated use. This is probably due to the fact that the resin B was not used and bonding of the amine compound progressed excessively, thereby causing localization of the electron transporting substance and dwelling of electrons by repeated use. The comparison between Examples and Comparative Example 14 reveals that even with the structure disclosed in PCT Japanese Translation Patent Publication No. 2009-505156, a sufficient effect of reducing the variation in positive ghosting is not always achieved in repeated use. This is probably due to the fact that the electron transporting substance is a polymer and thus aggregation of the components in the undercoat layer occurs when a cured film of a blocked isocyanate compound and a vinyl chloride-vinyl acetate copolymer is formed, resulting in swelling of electrons by repeated use. Comparison between Examples and Comparative Examples 9 to 13 reveals that in the case where the resin B and the electron transporting substance do not bond to each other and remain dispersed after being dissolved in a solvent, a sufficient effect of reducing the positive ghosting at an initial stage and a sufficient effect of reducing the variation in positive ghosting during repeated use are not always achieved. This is probably due to the electron transporting substance migrating to the upper layer (charge generating layer) during formation of the charge generating layer on the undercoat layer, resulting in a decrease in amount of electron transporting substance in the undercoat layer and dwelling of electrons caused by the electron transporting substance migrating to the upper layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A method for producing an electrophotographic photosensitive member comprising:
a support;
an undercoat layer formed on the support; and
a photosensitive layer formed on the undercoat layer, wherein the method comprises the steps of:
providing a composition comprising (i) to (iii),
forming the undercoat layer comprising a polymerized product obtained by polymerizing the composition,
(i) at least one selected from the group consisting of a compound represented by formula (C1) below, an oligomer of the compound represented by formula (C1), a compound represented by formula (C2) below, an oligomer of the compound represented by formula (C2), a compound represented by formula (C3) below, an oligomer of the compound represented by formula (C3), a compound represented by formula (C4) below, an oligomer of the compound represented by formula (C4), a compound represented by formula (C5) below, and an oligomer of the compound represented by formula (C5) 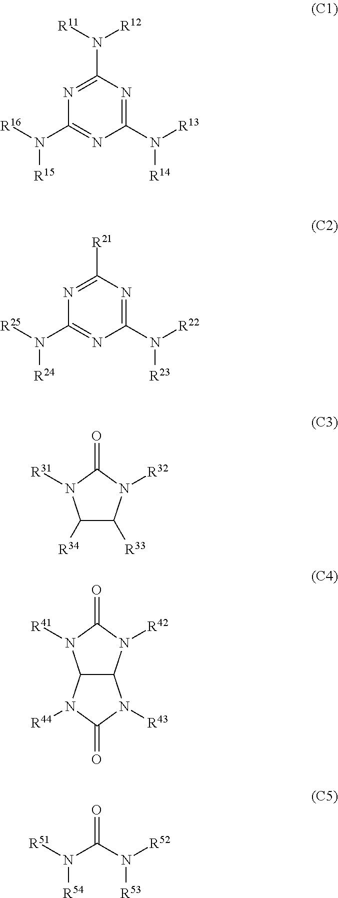
where R¹¹ to R¹⁶, R²² to R²⁵, R³¹ to R³⁴, R⁴¹ to R⁴⁴, and R⁵¹ to R⁵⁴ each independently represent a hydrogen atom, a hydroxy group, an acyl group, or a monovalent group represented by —CH₂—OR¹,
at least one of the R¹¹ to R¹⁶, at least one of the R²² to R²⁵, at least one of the R³¹ to R³⁴, at least one of the R⁴¹ to R⁴⁴, and at least one of the R⁵¹ to R⁵⁴ are each the monovalent group represented by —CH₂—OR¹,
R¹ represents a hydrogen atom, or an alkyl group having 1 to 10 carbon atoms, and
R²¹ represents an aryl group, an aryl group substituted with an alkyl group, a cycloalkyl group, or a cycloalkyl group substituted with an alkyl group;
(ii) a resin having a repeating structural unit represented by formula (B) below 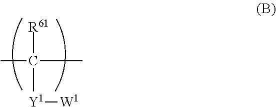
where R⁶¹ represents a hydrogen atom or an alkyl group, Y¹ represents a single bond, an alkylene group, or a phenylene group, and W¹ represents a hydroxy group, a thiol group, an amino group, a carboxyl group, or a methoxy group; and
(iii) an electron transporting substance having at least one substituent selected from the group consisting of a hydroxy group, a thiol group, an amino group, a carboxyl group, and a methoxy group, and
wherein the electron transporting substance is at least one selected from the group consisting of:
a compound represented by formula (A1) below,
a compound represented by formula (A2) below,
a compound represented by formula (A3) below,
a compound represented by formula (A4) below,
a compound represented by formula (A5) below,
a compound represented by formula (A6) below,
a compound represented by formula (A7) below,
a compound represented by formula (A8) below, and
a compound represented by formula (A9) below, 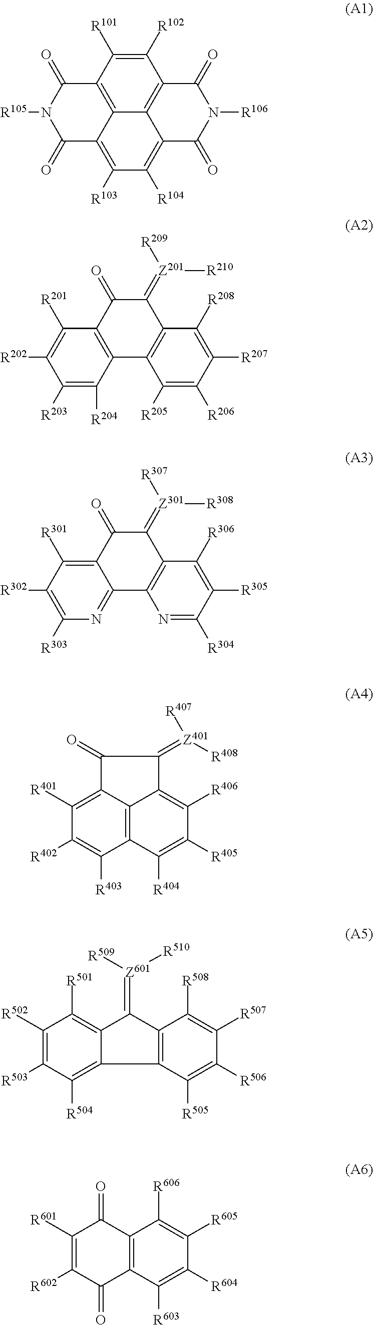 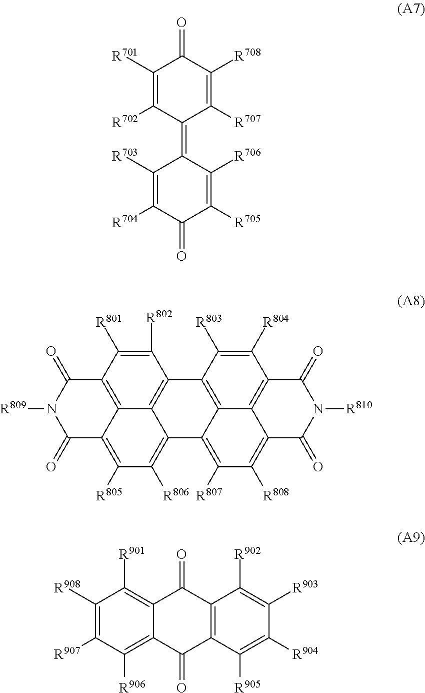
where R¹⁰¹ to R¹⁰⁶, R²⁰¹ to R²¹⁰, R³⁰¹ to R³⁰⁸, R⁴⁰¹ to R⁴⁰⁸, R⁵⁰¹ to R⁵¹⁰, R⁶⁰¹ to R⁶⁰⁶, R⁷⁰¹ to R⁷⁰⁸, R⁸⁰¹ to R⁸¹⁰, and R⁹⁰¹ to R⁹⁰⁸ each independently represent a monovalent group represented by formula (A) below, a hydrogen atom, a cyano group, a nitro group, a halogen atom, an alkoxycarbonyl group, a substituted or unsubstituted alkyl group, a substituted or unsubstituted aryl group, or a substituted or unsubstituted heterocyclic group,
at least one of the R¹⁰¹ to R¹⁰⁶, at least one of the R²⁰¹ to R²¹⁰, at least one of the R³⁰¹ to R³⁰⁸, at least one of the R⁴⁰¹ to R⁴⁰⁸, at least one of the R⁵⁰¹ to R⁵¹⁰, at least one of the R⁶⁰¹ to R⁶⁰⁶, at least one of the R⁷⁰¹ to R⁷⁰⁸, at least one of the R⁸⁰¹ to R⁸¹⁰, and at least one of the R⁹⁰¹ to R⁹⁰⁸ are each the monovalent group represented by the formula (A),
one of carbon atoms in the alkyl group may be replaced with O, NH, S, or NR¹⁰⁰¹, R¹⁰⁰¹ representing an alkyl group, and a substituent of the substituted alkyl group is an alkyl group, an aryl group, a halogen atom, or a carbonyl group,
a substituent of the substituted aryl group or the substituted heterocyclic group is a halogen atom, a nitro group, a cyano group, an alkyl group, a halogen-substituted alkyl group, an alkoxy group, or a carbonyl group,
Z²⁰¹, Z³⁰¹, Z⁴⁰¹, and Z⁵⁰¹ each independently represents a carbon atom, a nitrogen atom, or an oxygen atom,
R²⁰⁹ and R²¹⁰ are absent when Z²⁰¹ is the oxygen atom,
R²¹⁰ is absent when Z²⁰¹ is the nitrogen atom,
R³⁰⁷ and R³⁰⁸ are absent when Z³⁰¹ is the oxygen atom,
R³⁰⁸ is absent when Z³⁰¹ is the nitrogen atom,
R⁴⁰⁷ and R⁴⁰⁸ are absent when Z⁴⁰¹ is the oxygen atom,
R⁴⁰⁸ is absent when Z⁴⁰¹ is the nitrogen atom,
R⁵⁰⁹ and R⁵¹⁰ are absent when Z⁵⁰¹ is the oxygen atom, and
R⁵¹⁰ is absent when Z⁵⁰¹ is the nitrogen atom, 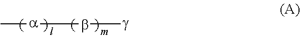
where at least one of α, β, and γ is a group having a substituent, the substituent being at least one group selected from the group consisting of a hydroxy group, a thiol group, an amino group, a carboxyl group, and a methoxy group,
l and m each independently represents 0 or 1,
the sum of 1 and m is 0 to 2,
a represents an alkylene group having 1 to 6 main-chain atoms, an alkylene group having 1 to 6 main-chain atoms and substituted with an alkyl group having 1 to 6 carbon atoms, an alkylene group having 1 to 6 main-chain atoms and substituted with a benzyl group, an alkylene group having 1 to 6 main-chain atoms and substituted with an alkoxycarbonyl group, or an alkylene group having 1 to 6 main-chain atoms and substituted with a phenyl group and may have at least one substituent selected from the group consisting of a hydroxy group, a thiol group, an amino group, a carboxyl group, and a methoxy group,
one of carbon atoms in the main chain of the alkylene group may be replaced with O, NH, S, or NR¹⁹, R¹⁹ representing an alkyl group,
β represents a phenylene group, a phenylene group substituted with an alkyl group having 1 to 6 carbon atoms, a phenylene group substituted with a nitro group, a phenylene group substituted with a halogen atom, or a phenylene group substituted with an alkoxy group and may have at least one substituent selected from the group consisting of a hydroxy group, a thiol group, an amino group, a carboxyl group, and a methoxy group, and
γ represents a hydrogen atom, an alkyl group having 1 to 6 main-chain atoms, or an alkyl group having 1 to 6 main-chain atoms and substituted with an alkyl group having 1 to 6 carbon atoms and may have at least one substituent selected from the group consisting of a hydroxy group, a thiol group, an amino group, a carboxyl group, and a methoxy group.

2. The method for producing the electrophotographic photosensitive member according to claim 1,
wherein the molecular weight of the electron transporting substance is from 150 to 1000.

3. The method for producing the electrophotographic photosensitive member according to claim 1,
wherein the weight average molecular weight of the resin is from 5,000 to 400,000.

4. The method for producing the electrophotographic photosensitive member according to claim 3,
wherein the weight average molecular weight of the resin is from 5,000 to 300,000.

5. The method for producing the electrophotographic photosensitive member according to claim 1,
wherein the (i) is at least one selected from the group consisting of the compound represented by formula (C1), the compound represented by formula (C2), the compound represented by formula (C3), the compound represented by formula (C4), and the compound represented by formula (C5), and
the molecular weight of the (i) is from 150 to 1000.

6. The method for producing the electrophotographic photosensitive member according to claim 1,
wherein the (i) is at least one selected from the group consisting of the compound represented by formula (C1), the compound represented by formula (C2), the compound represented by formula (C3), the compound represented by formula (C4), and the compound represented by formula (C5), and
in formulae (C1) to (C5), at least three of the R¹¹ to R¹⁶, at least three of the R²² to R²⁵, at least three of the R³¹ to R³⁴, at least three of the R⁴¹ to R⁴⁴, and at least three of the R⁵¹ to R⁵⁴ are each the monovalent group represented by —CH₂—OR¹.

7. The method for producing the electrophotographic photosensitive member according to claim 1, wherein the step of forming the undercoat layer comprises the steps of:
forming a coating film by using a coating solution for an undercoat layer, the coating solution containing the composition; and
heat-drying the coating film to polymerize the composition and form the undercoat layer.

8. The method for producing the electrophotographic photosensitive member according to claim 1,
wherein the resin having a repeating structural unit represented by formula (B) is a polyvinyl acetal resin or a polyester polyol resin.
